(19) United States
(12) Patent Application Publication
(10) Pub. No.: US 2002/0091728 A1
(43) Pub. Date: Jul. 11, 2002

(54) MULTIDIMENSIONAL ELECTRONIC SPREADSHEET SYSTEM AND METHOD

(76) Inventors: HENRIK KJAER, GREVE (DK); DAN KARE PEDERSEN, FREDERIKSBERG (DK)

Correspondence Address: BIRCH STEWART KOLASCH & BIRCH, PO BOX 747, FALLS CHURCH, VA, 22040-0747, US

(21) Appl. No.: 09/077,938

(22) PCT Filed: Dec. 6, 1995
(86) PCT No.: PCT/DK95/00490

(51) Int. Cl. G06F 17/00

(52) U.S. Cl. 707/503

(57) ABSTRACT

A multidimensional electronic spreadsheet system is provided, wherein different spreadsheet cells may be addressed by a different number of variables, thereby minimizing memory and processing time requirements of the electronic spreadsheet system. A group of cells addressed by more than two variables is displayed as a virtual highrise block positioned on a document, preferably a two-dimensional spreadsheet. For example, in a spreadsheet comprising 2D cells and 3D cells, the 2D cells are displayed in a 2D spreadsheet format. The 3D cells are visualized in perspective as cells positioned on top of each other along an axis perpendicular to the document. They are identified by rows and columns as for 2D cells and by a third variable in the third dimension. Cells addressed by a specific value of the third variable are said to constitute a storey. Multidimensional cells of identical row and column addresses are said to constitute a stack. Further, an intuitive method of controlling data processing, similar to methods known from 2D spreadsheets, e.g., when summing data along a row of cells or along a column of cells, is provided for data in three dimensions so that, e.g., summing data along stacks may be done in a similar manner. Thus, it is no longer necessary to create complex links between 2D spreadsheets to make calculations in three dimensions.

### FIELD OF THE INVENTION

The present invention relates generally to the field of information processing by computers and, more particularly, to the interfacing with the processing and presentation of information·y programme applications, particularly electronic spreadsheets.

### BACKGROUND OF THE INVENTION

Before computers, numerical analyses, particularly financial ones, were usually prepared on an accountants columnar pad or spreadsheet, with pencil and calculator in hand. By organizing data into columns and rows, spreadsheets afford rapid assimilation of information by a reader. The task of preparing a spreadsheet on paper, however, is very slow, as each entry must be tediously calculated and entered into the spreadsheet. Since all calculations are the responsibility of the preparer, manually prepared spreadsheets are also prone to errors. Hence, preparation of spreadsheets by hand is slow, tedious, and unreliable.

With the advent of microcomputers, a solution was forthcoming in the form of electronic spreadsheet systems. Better known simply as spreadsheets, these systems provide a computerized replacement for the traditional financial modelling tools: the accountants columnar pad, pencil, and calculator. Electronic spreadsheet systems offer dramatic improvements in ease of creating, editing, and using financial models.

A typical spreadsheet system configures the memory of a computer to resemble the column/row or grid format of an accountants columnar pad. Because this “electronic pad” exists dynamically in the computers memory, however, it differs from paper pads in several important ways. Locations in the electronic spreadsheet system, for example, must be communicated to the computer in a format which it can understand. A common scheme for accomplishing this is to assign a number to each row in a spreadsheet, and a letter to each column. To reference a location at column A and row 1, for example, the user types in “A1”. In this manner, the spreadsheet system defines an addressable storage location or spreadsheet cell in its memory for each intersection of a row with a column.

Corresponding to the configuration of the computers memory, the electronic spreadsheet system also displays a spreadsheet on a monitor to facilitate data entry, inspection, and manipulation. A spreadsheet is displayed as a grid-like table or matrix formed of a series of columns intersecting a series of rows. The columns extend from a peripheral horizontal axis of the matrix while the rows extend from a peripheral vertical axis of the matrix. Each row is labelled with a numeral (1, 2, 3 . . . ) along the peripheral vertical axis and each column is labelled with a letter (A, B, C, . . . ) along the peripheral horizontal axis. An intersection of a row and column forms a cell which receives a label formed by the composite of the respective labels of the row and column (e.g. C5) and this label also addresses the corresponding cell location in the computers memory.

Data entry into an electronic spreadsheet system occurs in much the same manner that information would be entered on an accountants pad. After a screen cursor is positioned at a desired location or cell of the displayed spreadsheet, the user can enter alphanumeric information into the cell. Besides holding text and numeric information, however, the cells can store special instructions or formulas specifying calculations to be performed on numbers stored in cells. In this way, cell references can serve as variables in an equation, thereby allowing precise mathematical relationships to be defined between cells. The structure and operation of a spreadsheet system, including advanced functions such as functions and macros, are documented in the technical, trade, and patent literature.

According to the foregoing grid structure, spreadsheets have been referred to as two-dimensional, i.e. having two axes along which information could be located. In EP 0 569 153 a pseudo three-dimensional spreadsheet is disclosed, wherein a series of two-dimensional spreadsheets have been used as a collection to provide a third dimension. Each spreadsheet in the series or collection is thought to extend from a position along a third axis. That is, the third axis provides a link from one spreadsheet to another in the series. Each spreadsheet in the series has the two axis format with numbered rows and lettered columns. And each cell has a composite label as described previously but with an additional indication of the particular spreadsheet in the series of spreadsheets on which the cell is located. Additional dimensions provide links between different series of spreadsheets.

It is known to visualize a series of two dimensional spreadsheets as a notebook having a plurality of notebook pages, each of which is a two-dimensional spreadsheet or another page type, such as a page with charts. Individual notebook pages are identified by page identifiers, e.g. in the form of a tab member situated along a bottom edge of the notebook. A specific spreadsheet may be selected by moving a screen cursor to the corresponding tab and clicking a mouse.

In a typical application of a pseudo three-dimensional spreadsheet, first spreadsheet of a notebook is used for e.g. sales figures of a company, a second spreadsheet is used for charts, and a third spreadsheet is used for macros generating the charts. Clearly, in this example the pseudo three-dimensional spreadsheet is used for an adequate partitioning of data providing an improved overview of data to the user compared to that of a two-dimensional spreadsheet.

There are various disadvantages to spreadsheets of the above-mentioned kind, both two-dimensional and multi-dimensional based on a series of spreadsheets. The amount of data that can be effectively treated in known spreadsheet are limited. Typically, only a small part of a large arrangement of data can be displayed on a monitor at the time making it difficult to get an overview of even simple interrelations between data of the spreadsheet. Further, to carry out advanced data processing, it is generally necessary to use macros which only highly qualified users may master and which are different for different spreadsheets.

It is another disadvantage of known spreadsheets that only per cell formulas are employable in current spreadsheets. That is, cells are referenced by the fixed row/column labelling scheme. Hence, a degree of effort and care is required to maintain coordination between cells and respective cell formulas, especially for cells addressed by three or more variables.

WO 92/04678 and U.S. Pat. No. 5,418,898 each discloses a multidimensional spreadsheet wherein each cell may be addressed by a large number of variables. The cells are displayed in a two-dimensional format. The user selects the variables to be displayed along the horizontal and the vertical axis, respectively. Each axis may be subdivided into groups in a hierarchical way so that a plurality of dimensions may be displayed along an axis, e.g. the horizontal axis may be divided into years, each year being divided into months, each month being divided into weeks, etc.

It is a disadvantage of multidimensional spreadsheets known in the art that all cells are addressed by the same number of variables. Thus, the addressing and reference schemes become fairly complex and extensive.

It is a further disadvantage of multidimensional spreadsheets known in the art that cells are displayed in a two-dimensional format which limits the users possibilities of getting an overview of spreadsheet data and structure, e.g. as it is typically experienced when similar data, has to be entered into several spreadsheets, each spreadsheet representing, e.g., different time periods, different geographical areas, etc, such as when sales figures for specific items have to be entered for various countries.

### SUMMARY OF THE INVENTION

It is an object of the present invention to provide a multidimensional electronic spreadsheet system and method, wherein different cells of the spreadsheet may be addressed by a different number of variables, thereby minimizing memory and processing time requirements of the electronic spreadsheet system.

It is another object of the present invention to provide a multidimensional electronic spreadsheet system and method, wherein a calculation of a formula comprising as input values, numerical values stored in cells positioned along a specific dimension of the spreadsheet, is carried out upon a very simple user entry, such as a click of the mouse.

It is still another object of the present invention to provide a multidimensional electronic spreadsheet system and method, wherein groups of cells may be displayed in a perspective three-dimensional format.

It is yet another object of the present invention to provide a multidimensional electronic spreadsheet system and method, wherein cells may be sorted according to data stored in them along the dimension displayed in perspective as a third dimension, e.g. on a display or a printer.

It is a further object of the present invention to provide a multidimensional electronic spreadsheet system and method, wherein graphical means are provided for simultaneous display of data stored in cells of more than two dimensions.

It is a still further object of the present invention to provide a multidimensional electronic spreadsheet system and method, wherein a part of the electronic spreadsheet system including a selected set of cells may be transferred to a computer system, e.g. through a network via a movable storage medium, etc., in such a way that a user of the receiving computer system, executing the part of the electronic spreadsheet system transferred to it, can read, change and/or recalculate contents of cells of the selected set of cells and transfer the updated contents of the selected set of cells back to corresponding positions in the original electronic spreadsheet system.

It is a further object of the invention to provide a new paste function for pasting the contents of selected source cells addressed by two or more variables into selected target cells, wherein the address values of input variables of a formula in a source cell is incremented by a user selected value when the corresponding address variable of the target cells is incremented by one.

According to the invention these and other objects are fulfilled by an electronic spreadsheet system comprising

a computer having memory means for storage of data and processing means for defining addressable spreadsheet cells stored in the memory means, for entering data into the spreadsheet cells and for processing data stored in the spreadsheet cells,

input means for entering data into the system, and

display means for displaying cells as a spreadsheet,

wherein at least one cell is addressable by a first number of variables that differs from a second number of variables addressing another cell.

An electronic spreadsheet system according to the invention may comprise all features and functions of known spreadsheets, such as cell display format features, mathematical functions, charts, cell protection features, user interface features, such as icons, tools, toolbars, etc., etc.

For example, a cell may contain various types of data, such as a numerical value, an alphanumeric string, a logical value, a formula, etc.

Further, various features of a cell may be specified by a user, features such as character fonts used to display the contents of a cell, attributes of displayed characters, such as underline, overline, bold, italic, etc., justification in a cell of a string displayed, such as left, right, center, etc., attributes of displayed borders, patterns, and colors of cells, etc.

Cells may be copied, pasted, moved, etc., either into the current spreadsheet or into another spreadsheet, and cells may be inserted into, deleted from, or cleared in the current spreadsheet.

Graphical objects, such as lines, arrows, rectangles, ellipses, arcs, polygons, text boxes, etc., may be created in the spreadsheet.

Charts, such as line charts, pie charts, bar charts, area charts, column charts, XY (scatter) charts, radar charts, 3D type charts, etc., based on cell data can be created.

It is a significant advantage of a spreadsheet system according to the invention that there is no need to address all cells of the spreadsheet with the same number of variables. This feature leads to considerable savings in memory requirements and processing time requirement compared to such requirements of known multidimensional spreadsheets wherein all cells have to be addressed by the same number of variables.

In a preferred embodiment of the invention, the spreadsheet system comprises at least one cell (2D cell) that is addressed by two variables or at least one cell (3D cell) that is addressed by three variables, and preferably the spreadsheet system comprises at least one cell (2D cell) that is addressed by two variables and at least one cell (3D cell) that is addressed by three variables.

2D cells of a spreadsheet system according to the invention constitutes a so called global area of the spreadsheet. The global area of the spreadsheet may comprise all the features known from prior art two-dimensional spreadsheets.

A spreadsheet may comprise a plurality of global areas to be used with a common set of multidimensional data and preferably displayed one at the time. A large set of multidimensional data may be used for many different purposes and it may be an advantage for the user having finished one set of investigations and calculations on such a data set to be able to start a new set of investigations and calculations in a new global area. This corresponds to start new calculations on a clean sheet of paper using paper and pencil. Also various scenarios may be created using separate global areas.

A global area may be stored in a file for later use, i.e. the contents of selected cells of a global area, such as a data value, a text, a format specification, a formula, etc., or any combination hereof may be stored.

It is another significant advantage of the invention that multidimensional cells are treated by the spreadsheet system in a similar manner as two-dimensional cells are treated in known two-dimensional spreadsheets, e.g. the invention provides the same user friendliness when entering data and formulas in three or more dimensions as provided for two-dimensional data and formulas by known two-dimensional spreadsheet systems.

2D cells of a spreadsheet are displayed in two dimensions by means for displaying cells, such as a CRT monitor, a LCD display, a printer, etc., in a way known from two-dimensional spreadsheets as already described, i.e. as a grid-like table or matrix for holding desired data. Typically, the grid-like table or matrix is formed of a series of columns intersecting a series of rows. The columns extend from a peripheral horizontal axis of the matrix while the rows extend from a peripheral vertical axis of the matrix. Each row is labelled with a numeral (1, 2, 3 . . . ) along the peripheral vertical axis and each column is labelled with a letter (A, B, C, . . . ) along the peripheral horizontal axis. An intersection of a row and column forms a cell which receives a label formed by the composite of the respective labels of the row and column (e.g. C5).

According to a preferred embodiment of the invention, a group of cells addressed by more than two variables is displayed as a virtual highrise block positioned on a document, preferably a two-dimensional spreadsheet. For example, in a spreadsheet comprising 2D cells and 3D cells, the 2D cells are displayed as described above in a 2D spreadsheet. The 3D cells are visualized in perspective as cells positioned on top of each other along a z-axis perpendicular to the document. They are identified by rows and columns as for 2D cells and by a third variable in the third dimension. Cells addressed by a specific value of the third variable are said to constitute a storey. For example, a 3D cell positioned at an intersection of column C and row 5 and at storey 3 may be denoted C5_{—}3. 3D cells may be created anywhere in relation to 2D cells and groups of any number of 3D cells may be positioned adjacent to each other. Multidimensional cells of identical row and column addresses are said to constitute a stack.

It is an important advantage of the present invention that category labels (i.e. headines of columns and rows) and formulas relevant for all storeys of a highrise block need only be stored in one two-dimensional cell in the global area whereby considerable savings in memory requirements and processing time requirement compared to known multidimensional spreadsheets are provided.

In a spreadsheet comprising 4D cells, i.e. cells addressed by four variables, 4D cells may be displayed as different rooms in a storey. The rooms of a storey may be identified by displaying them with different colors or by displaying an identifier, such as a number, a letter, etc., with the room.

It is preferred to display cells of a selected storey at the top of a virtual highrise block in a way similar to the way of displaying 2D cells. The user can select any storey of the virtual highrise block for display. Having selected a specific storey for display, all cells of that storey are displayed on top of the corresponding highrise block. Preferably, the user is enabled to do any operation allowed on 2D cells on cells displayed on the top of a highrise block.

Each storey of a highrise block may have an identifier, such as a name, a number, etc., attached to it. The identifier may be specified automatically by the system or by a user of the system. For example, an annual sales budget may comprise 12 storeys, one for each month of the year, and each storey may carry the name of the corresponding month so that a user of the system may easily identify data of a specific storey. The identifier may substitute the corresponding address value in references to cells of the storey in question.

Similarly, each cell of the spreadsheet may have an identifier, such as a name, a number, etc., attached to it. The identifier may substitute the corresponding address value in references to the cell in question.

It is an important advantage of the present invention that displaying multidimensional data as one or more virtual highrise blocks positioned on a two-dimensional spreadsheet provides a user with a very intuitive perception and overview of data. In order to inspect contents of cells along a third dimension, it is no longer necessary to turn pages of a notebook and thereby losing track of data interrelations, instead contents of cells of a virtual highrise block can be looked through without changing position of other cells with important relations to data of the highrise block.

Further, an intuitive method of controlling data processing, similar to methods known from 2D spreadsheets, e.g. when summing data along a row of cells or along a column of cells, is provided for data in three dimensions so that, e.g., summing data along stacks may be done in a similar manner. Thus, it is no longer necessary to create complex links between 2D spreadsheets to make calculations in three dimensions. Further, for enhanced control of data processing, various criteria may be related to each storey of a block for inclusion or exclusion of data of a specific storey in the calculation.

It is still another important advantage of the present invention that it combines features of a spreadsheet with features of a data base.

When a new spreadsheet is to be created, the electronic spreadsheet system initially displays a clean two-dimensional spreadsheet. The user may then select an area of the two-dimensional spreadsheet comprising one or more cells and create a block of cells comprising a plurality of layers of cells positioned on top of the selected area. Each layer of cells constitutes a storey of the block. The block is visualized, e.g., by displaying a shadow around the block, or by displaying a specific color around the block, by displaying a number of lines around the block, etc., so that blocks of multidimensional cells can be clearly identified by the user of the system. The number of storeys in a block is specified by the user.

A block may be positioned anywhere in the two-dimensional spreadsheet and may comprise any number of cells.

More cells may be added to an existing block of cells by selecting 2D cells to be included in the block in question and cells may be deleted from a block, e.g. by turning the cell of the top storey of the block in question into a 2D cell.

A block may be deleted, e.g. by turning cells of its top storey into 2D cells.

Storeys may be added to an existing block and storeys may be deleted from an existing block.

When storeys are added to a block, the system may add the storey on top of the existing block or the user may select at which storey level to insert the new storey. The new storey may consist of empty cells or the user may select to copy contents of cells of an existing storey into corresponding cells of the new storey or to copy the format of an existing storey into the new storey. Further, the user may select to copy a storey template created earlier into the new storey.

A storey may be moved to another storey level and storeys may be swapped with each other.

Information of a selected block, such as number of cells, number of storeys, cell formats, etc., may be displayed upon execution of a selected command.

Likewise, information about a selected storey, such as its identification, storey level, number of cells, etc., may be displayed upon execution of a selected command.

A block may be hidden, i.e. by displaying the cells of a selected storey as 2D cells.

A storey of cells may be saved as a storey template to be used as a master when a new block or a new storey of an existing block has to be created.

Cells of a highrise block of identical row and column addresses constitute a stack. Cells of a stack may be displayed in different formats. One or more stacks may be copied into a selected group of 2D cells or into selected stacks either in the existing spreadsheet or in another spreadsheet.

Instead of copying contents of first selected cells into second selected cells as described above numerical values of first cells may be added to, subtracted from, multiplied by, divided by, or divided into data values of the second cells. In the present context such an operation is denoted a paste special operation.

Copy and paste commands are provided, wherein the user can define the cell address adjustments.

A new paste function is provided for pasting the contents of selected source cells addressed by two or more variables into selected target cells, wherein the address values of input variables of a formula in a source cell is incremented by a user selectable value when the corresponding address variable of the target cells is incremented by one.

Predefined series of data may be copied into cells of a stack, e.g. the names of the months may be copied into 12 cells of a stack. Empty cells may be maintained at predetermined intervals when a predefined series is copied into a stack.

Cells of a selected stack may be displayed as a list of data. A storey may be marked so that data of cells of that storey is not displayed in the list. The mark can be removed. Upon selection of a specific cell in the list, the corresponding storey may be displayed on top of the highrise block.

A storey may be marked so that the storey can not be displayed on top of the corresponding highrise block. The mark can be removed.

A subset of storeys can be selected, e.g with a click of the mouse, so that only the selected storeys can be displayed on top of the corresponding highrise block.

The storeys of a block may be displayed as overlaid two-dimensional spreadsheets so that the user may identify a specific storey with a screen cursor. The identified storey may be displayed on top of the overlaid spreadsheets upon execution of a selected command.

Further, selected storeys of a block may be displayed in a two-dimensional format side by side.

Cells of one or more selected stacks may be displayed side by side in a two-dimensional format, e.g. along a vertical or horizontal line. A stack identifier may be displayed with the corresponding cells.

In a formula of a cell, e.g. a 2D cell, references can be made to cells of the storey displayed. This kind of reference is denoted a relative block reference, i.e. the relative block reference only specifies the row and column addresses of a cell. The cell actually used as a data source in the formula will be the cell displayed in the displayed storey and with the referenced row and column addresses. For example, when a relative block reference is made in a formula of a 2D cell, the value of the 2D cell is calculated from values of the corresponding cells displayed in the displayed storey of the corresponding virtual highrise block. Thus, the value displayed in the 2D cell will typically change when cells of another storey are displayed in the displayed storey of the highrise block in question.

With relative block references, it is also possible to compare data in the global area with data displayed in the displayed storey of a highrise block. The result of the comparison will change, when a new storey is displayed.

A formula stored in a cell may be referenced by a user selected name and stored for later use, e.g. as a menu command, as a tool in a tool bar, etc.

Further, charts may be generated by graphical means graphically presenting data referenced by relative block references. Thus, when a storey displayed is exchanged with another storey the chart is changed accordingly. In this way results of comparisons between data of a displayed storey and data of the global area may be illustrated graphically. When a new storey is displayed, the corresponding chart is changed according to the values of the new cells displayed.

Further, formulas of a cell may reference any cell of the spreadsheet whether such cells are displayed or not. Thus, the displayed value of e.g. a 2D cell does only change if the value of a referenced cell is changed.

The contents of cells or groups of cells can be protected so that the contents cannot be changed until the protection is removed.

A block may be searched for specific data. Storeys may be marked to be included in or excluded from a search. If the searched data is found the storey with the cell with the found data is displayed on top of the corresponding highrise block and the cell is indicated.

A search key may be referenced by a user selected name and stored for later use, e.g. as a menu command, as a tool in a tool bar, etc.

A block may be moved from one position on a spreadsheet to another position.

In spreadsheets comprising two or more blocks, display interconnections may be established between some or all of the blocks so that storeys of the same storey level is displayed on the blocks between which display interconnections have been established. Further, display interconnections may be established between blocks so that the storey level displayed on top of one highrise block is an integer multiple of the storage level displayed on top of another highrise block.

A plurality of tools are provided for selection of a storey to be displayed on top of the corresponding highrise block. For example, a list of storey identifiers identifying each storey of a selected highrise block can be displayed upon execution of a corresponding command and a storey can be selected for display by selection of the corresponding identifier from the list, e.g. by moving a screen cursor to the desired identifier and clicking the mouse.

Further, an icon is provided upon selection of which the storey level of the storey displayed is incremented by one, and another icon is provided upon selection of which the storey level of the storey displayed is decremented by one.

Further, tools for selecting that the bottom storey is to be displayed and for selecting that the top storey is to be displayed may be provided.

Tools for moving a storey to another storey level may also be provided.

Cells of a storey may be marked in such a way that data has to be entered into the marked cells when the corresponding storey is displayed before a new storey can be displayed.

Cells of a stack may be marked in such a way that the data contents of the marked cells has to be different. If a user tries to enter identical data into two marked cells, the system issues a warning and data entrance is denied.

Tools are also provided for stepping through storeys of a block by incrementing or decrementing the storey level number of the storey displayed at the top of the block by a selected integer. Further, storeys may be marked for not being displayed during a session of stepping through storeys of a block.

The order in which a number of storeys are displayed may be recorded for later playback upon execution of a corresponding command.

In known two-dimensional spreadsheets, it is fairly easy to enter formulas with input values from a row of consecutive cells or a column of consecutive cells. Typically, a section of a row or column of consecutive cells is selected by dragging a screen cursor across the cells to be selected using a mouse followed by selection of a numerical calculation, such as a summation, to be carried out on numerical data of the selected cells. A similar feature is provided in the third dimension of a spreadsheet according to the invention. One or more stack of cells are very easily selected, e.g. by dragging a screen cursor across the stack of cells to be selected using a mouse followed by selection of a numerical calculation, such as a summation, to be carried out on numerical data of cells of the selected stacks. Calculations of this kind are denoted block calculations.

Various criteria may be related to each storey of a block. For example, a dialogue box may be displayed upon execution of a corresponding user command in which box the user can specify whether or not the storey currently displayed is of a specific kind, e.g. making it relevant as source of input data for certain calculations, charts, etc. A block calculation may reference one or more of various criteria for inclusion or exclusion of data of a specific storey in the calculation. For example, if a highrise block contains information relating to medical test results of a number of patients and each storey of the highrise block contains data of one patient, averages may be calculated for a group of specific patients defined by attributes specified in the above-mentioned dialogue boxes relating to the storeys. For example, a summation of numerical values of a stack of 3D cells may be specified as BSUM(A4) which sums the numerical values of cells in the stack at the address A4 while BSUM(A4;[criterion A; criterion B]) sums the numerical values of cells in the stack at the address A4 of storeys fulfilling both criterion A and B.

Whether or not a storey displayed fufils a certain criterion may be indicated in the display, e.g. by displaying a specific color at the edges of the storey, by displaying a tag at an edge of the storey, etc.

Criteria of the above-mentioned kind may also be specified for one or more 2D cells.

Criteria of the above-mentioned kind may be specified for 2D cells or storeys one by one or for selected groups of 2D cells or selected groups of storeys simultaneously.

A group of cells of the spreadsheet, such as a storey, together with display and processing means may be transferred to a computer in such a way that a user operating the computer can read, change and/or recalculate the contents of the group of cells and transfer the updated contents of the group of cells back to the electronic spreadsheet system. Thus, a run-time version of a part of the spreadsheet may be transmitted to a user.

This feature allows an accountant to create a spreadsheet adapted to the needs of a specific group of clients and to transmit a part of the prepared spreadsheet, e.g. comprising a storey, without numerical data but with established formulas and charts to a client. The client may then enter his or her data, such as numerical values, into the received part of the spreadsheet and inspect results of calculations and displayed charts based on his or her data. After such a session, the client may transmit the part of the spreadsheet with his data-back to the accountant and the spreadsheet system will then enter the received data into the corresponding part of the spreadsheet, such as the appropriate storey for the client in question.

Selected cells of the run-time version of the spreadsheet may be protected so that their contents can not be changed.

The transfer of part of the spreadsheet may be performed by any suitable means, such as through local area networks or wide area networks, such as Internet, etc., by a movable storage medium, such as a diskette, a memory card, etc., etc.

Data transferred may be encrypted before transmission and decrypted upon reception.

Data from other documents may be entered into the spreadsheet in a manner similar to the above. For example, each page of a document may be entered into a specific storey of a highrise block. If a storey is too small to receive a document, the corresponding block is automatically enlarged by adding new stacks to the block.

Storeys of a highrise block may be sorted according to the contents of cells of a selected stack. The sorting may be done in increasing or decreasing order and alphanumeric strings may be sorted. The sorting of cells in a stack is denoted block sort. The sequence of storeys of the highrise block is either rearranged as a result of the sorting operation or only the cells sorted are rearranged whereas the sequence of storeys remains unchanged whereby storeys exchange cells so that each sorted cell is entered into the appropriate storey fitting the sorted sequence of the cells.

Various criteria may be referenced in a block sort command in a way similar to criteria referenced made in block calculations as described previously. Only storeys fulfilling criteria specified in the block sort with criteria command are sorted.

Preferably, the spreadsheet system comprises graphical means for graphically displaying data values of selected cells. By a block chart command, data values of selected stacks of cells are displayed in a chart. Again, criteria may be specified for inclusion or exclusion of data from cells of a given storey in the chart.

As the spreadsheet system according to the invention is adapted to handle huge amounts of data, it may also be used in an electronic data base system by incorporating data base features into the system. For example, a window for data entry may be displayed which may be similar to known windows of an electronic data base system with all known features of such windows.

Preferably, data of a record of the data base is stored as a specific storey of a highrise block of the spreadsheet system. The data base may be object oriented.

The spreadsheet system may comprise an electronic relational data base system as cells of various blocks of the spreadsheet system can be related to each other.

Further, the spreadsheet system may be adapted to be used in an electronic expert system in that the rules of the expert system may be implemented using the search, sorting, calculation, etc., features of the spreadsheet and the data base of the expert system may be implemented by storing data of its data base in storeys of blocks as described above.

The electronic spreadsheet system may be adapted to show a specified storey in a specified block by use of an automatic browse function.

Further, this functionality may be extended to depend on the contents of specified cells. Thus, when a certain cell contains a certain value etc. specified storey in a specified block is made the displayed storey.

### BRIEF DESCRIPTION OF THE DRAWINGS

The invention will now be described by way of example and with reference to the accompanying drawings in which:

FIG. 1 shows a highrise block with several storeys of three-dimensional cells positioned on a two-dimensional spreadsheet The block of three-dimensional cells is visualized in perspective as cells positioned on top of each other,

FIG. 2 shows a highrise block,

FIG. 3 shows a selected cell,

FIG. 4 shows a plurality of selected cells,

FIG. 5 shows a block having empty cells,

FIG. 6 shows a spreadsheet, wherein a block cell (B3_{—}1) is displayed,

FIG. 7 shows the spreadsheet of FIG. 6, wherein the block cell (B3_{—}2) is displayed,

FIG. 8 shows a storey of block cells having numerical values,

FIG. 9 shows a new storey with empty cells,

FIG. 10 shows a pop-up menu positioned in the upper left corner of the document. The pop-up menu lists the names of the storeys,

FIG. 11 shows a dialogue box for changing the name of a storey,

FIG. 12 shows a block before expansion,

FIG. 13 shows the block of FIG. 12—now expanded with a new block cell,

FIG. 14 shows how to add values of block cells together using Top Cell References,

FIG. 15 shows the summation of FIG. 14 recalculated for another storey with different values in the displayed cells,

FIG. 16 shows a comparison between numerical values in the displayed storey and numerical values in the global area,

FIG. 17 shows the comparison of FIG. 16 but for another displayed storey,

FIG. 18 shows a comparison between values in two blocks. The numerical values are subtracted from each other and the result is indicated in the global area,

FIG. 19 shows the comparison of FIG. 18 but for another displayed storey in one of the blocks,

FIG. 20 shows other calculations performed in a block. The input values are positioned in the global area,

FIG. 21 shows another storey with another calculation,

FIG. 22 shows how to add values of block cells together using cell references,

FIG. 23 is identical to FIG. 22 except that another storey is displayed,

FIG. 24 shows the Paste Special dialogue box,

FIG. 25 shows the Block menu, which contains most of the important menu commands to be applied to a block,

FIG. 26 shows how to go from one storey to another by using the pop-up menu in the upper left corner of the document.

FIG. 27 shows how to scroll down the pop-up menu,

FIG. 28 shows the special Pop-up menu under the selected cell. The pop-up menu shows the cell values of the stack,

FIG. 29 shows how to get from one storey to another using the pop-up menu under the selected cell,

FIG. 30 shows a block function,

FIG. 31 shows the block function of FIG. 30 and the corresponding stack displayed in a pop-up menu,

FIG. 32 shows the use of normal functions in the block,

FIG. 33 shows a bar chart,

FIG. 34 shows a bar chart that changes when the storey is changed. The title of the chart is changed accordingly,

FIG. 35 shows the bar chart of FIG. 34 for another storey displayed,

FIG. 36 shows another bar chart,

FIG. 37 shows the bar chart of FIG. 36 for another storey,

FIG. 38 shows a Block Chart and the corresponding stack in a pop-up menu,

FIG. 39 shows an IF sentence with a top cell reference,

FIG. 40 shows the IF sentence of FIG. 39 with another storey displayed,

FIG. 41 shows an example of a spreadsheet according to the invention used for calculation of sales figures,

FIG. 42 shows the spreadsheet of FIG. 41 with the total sales of a year for one salesman,

FIG. 43 shows the spreadsheet of FIG. 41 with total sales and the sales for each salesman,

FIG. 44 shows a spreadsheet according to the invention used for medical tests,

FIG. 45 shows a comparison of data of several storeys,

FIG. 46 shows the result of execution of a Copy/Paste function in a traditional spreadsheet,

FIG. 47 shows another result of execution of a Copy/Paste function in a known spreadsheet with resulting gaps between cells after execution,

FIG. 48 shows the result of execution of a Paste Special with Variable Cell Address Adjustment,

FIG. 49 shows the flowchart of the Paste Special function with Variable cell Address Adjustment,

FIG. 50 shows the internal architecture of the electronic spreadsheet system,

FIG. 51 shows a flowchart of the cell dependencies.

### DETAILED DESCRIPTION OF THE DRAWINGS

It is a disadvantage of traditional spreadsheets that cells are only displayed in a two-dimensional format which limits the users' possibilities of obtaining an overview of spreadsheet data and structure, e.g. as it is typically experienced when similar data has to be entered into a spreadsheet as a function of time or as a function of geographical relations of the data, such as when sales figures for specific items have to be entered for various countries.

In the present electronic spreadsheet system, the cells need not be addressed by the same number of variables.

Only one document is needed in order to build an area with several layers of cells, and as the cells in these layers can be used for calculations together with the cells outside of this multidimensional area, this construction offers an entire new world of options when calculating in the third dimension. For example scientific models or budgets covering several years can be built much more easily compared with using a traditional spreadsheet. Calculation in the third dimension is facilitated and calculations that could not be made in traditional spread sheets can be performed.

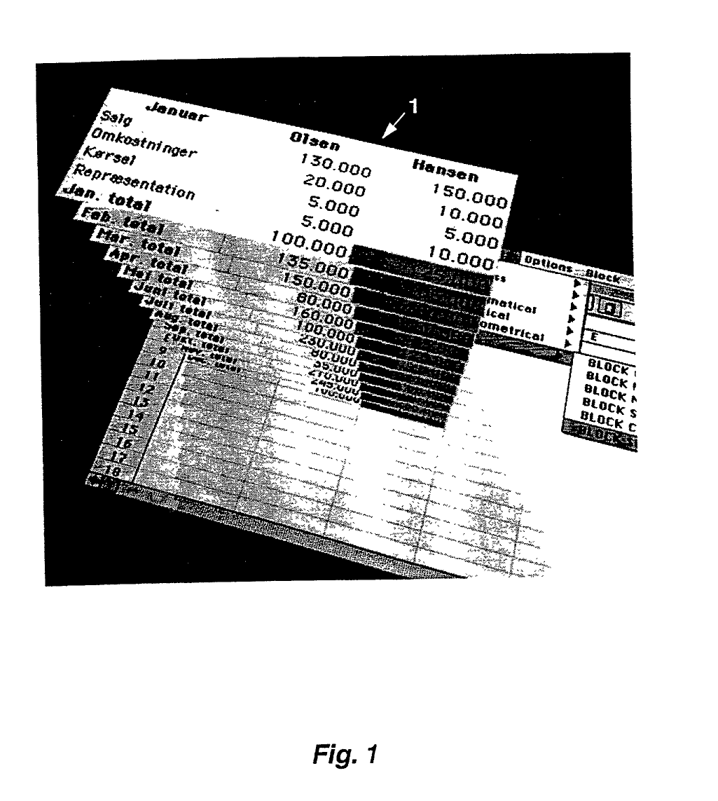

To illustrate the principle and the advantage of addressing various cells in a spreadsheet having a different number of variables, FIG. 1 shows a block of three-dimensional cells (1) positioned on a spreadsheet (two-dimensional cells). The block of three-dimensional cells is visualized in perspective as cells positioned on top of each other.

The block

When desiring to work in the third dimension, a block of 3D-cells is simply created at the exact position selected for the three-dimensional area. The block can contain several layers of these 3D-cells (block cells).

The 2D cells of the electronic spreadsheet system constitute a so-called global area in the spreadsheet.

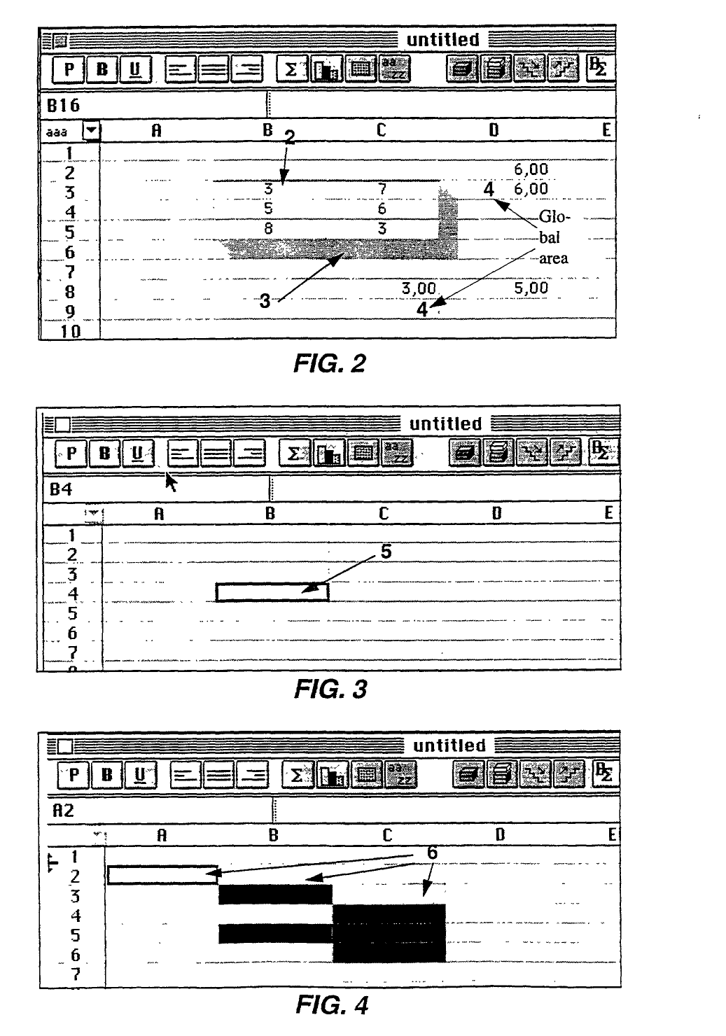

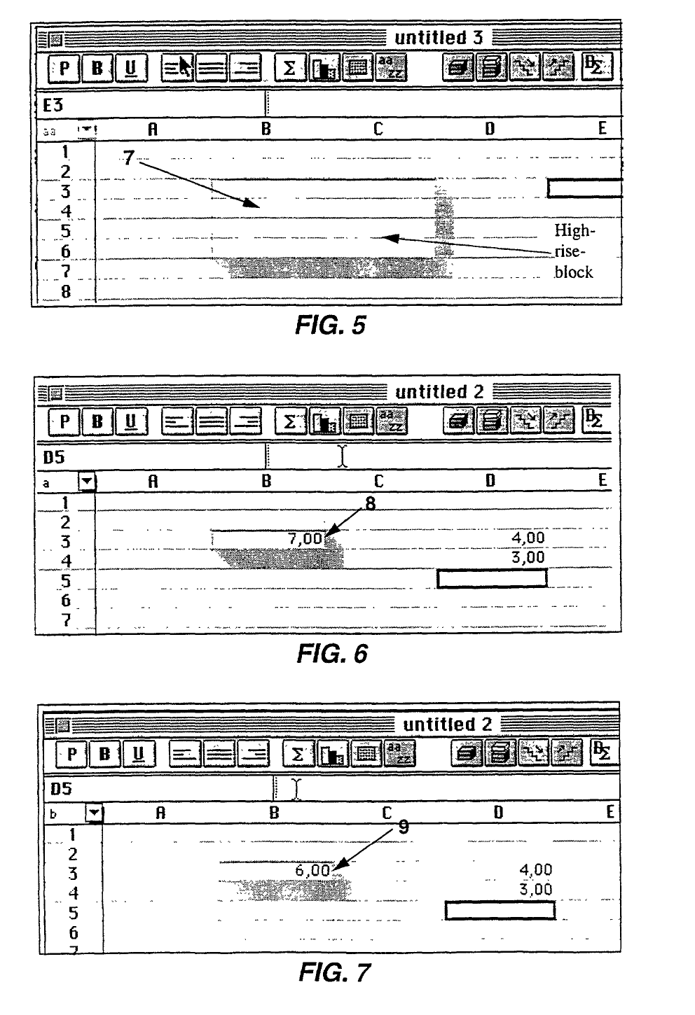

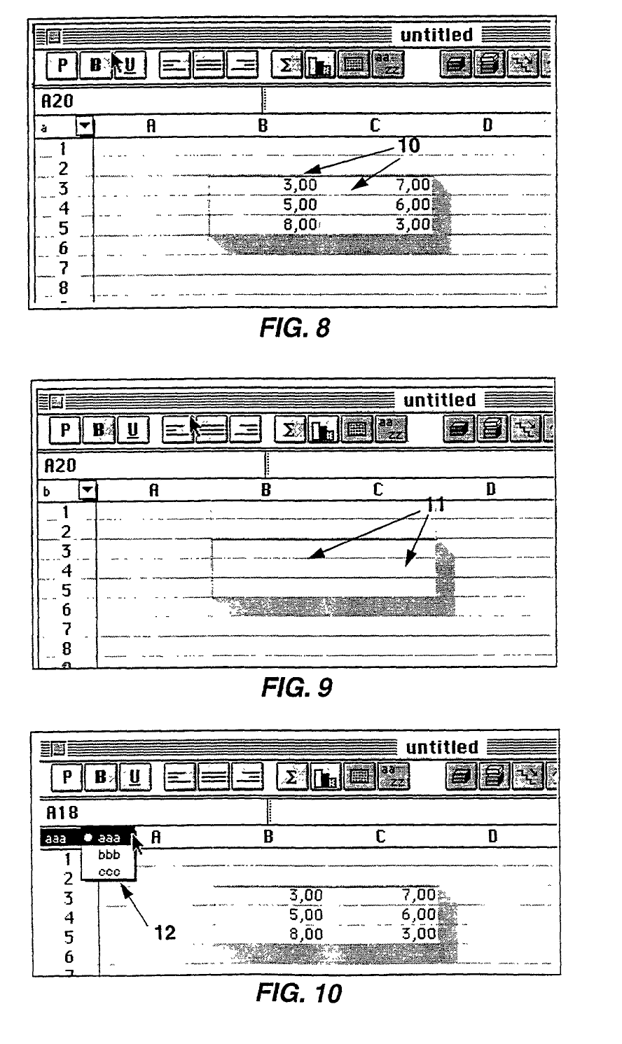

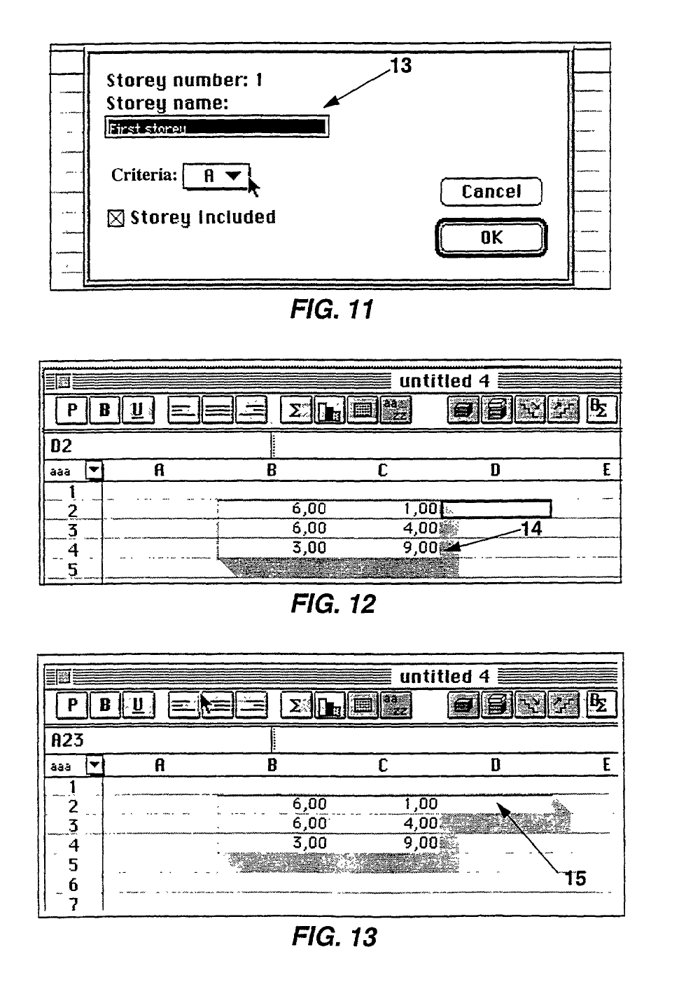

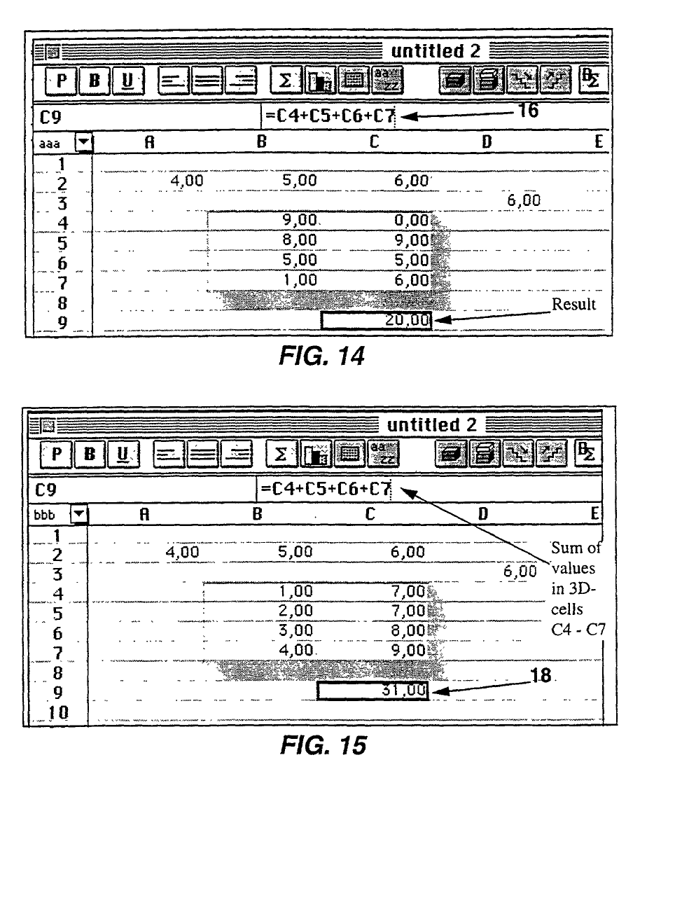

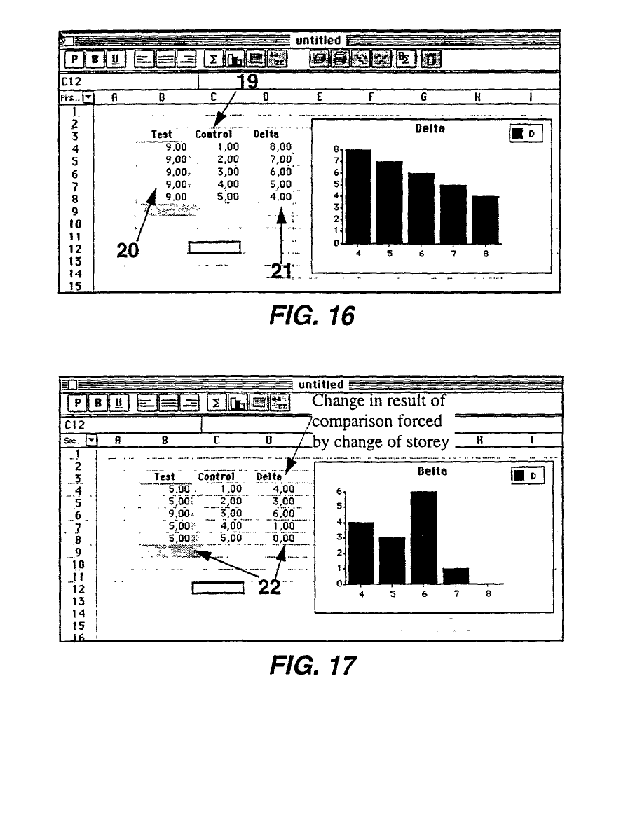

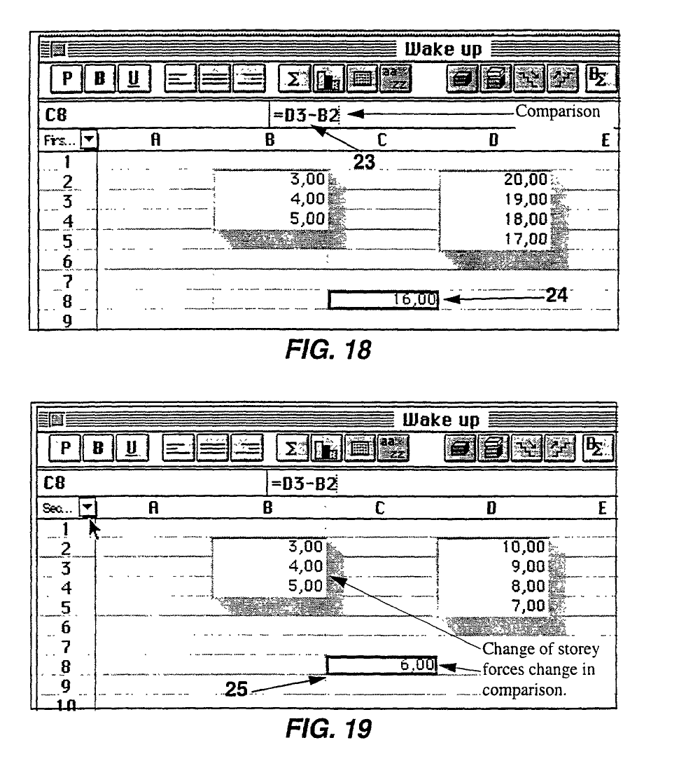

FIG. 2 shows a block covering the cells from B3 to C5 (2). Surrounding the block a shadow (3) indicates the depth. Outside the block, the global area (4) is seen.

The electronic spreadsheet system comprises known features

The global area of the spreadsheet comprises normal features and functions of known spreadsheets, such as cell display format features, mathematical functions, charts, cell protection features, user-interface features, such as icons, tools, toolbars, etc., etc., and a user operates on these cells in a similar manner as a user operates on cells in known spreadsheets.

The electronic spreadsheet system comprises both ordinary (2D) cells and block cells. A user operates on 2D cells in a similar manner as a user operates on cells in known spreadsheets. Block cells are always positioned in a block. A detailed description of functions and features relating to block cells is given below.

A cell can contain various types of data, such as a numerical value, an alphanumeric string, a logical value, a formula, etc.

Further, various features of a cell may be specified by a user, such as character fonts used for displaying the contents of a cell attributes of displayed characters, such as underline, overline, bold, italics, etc., justification in a cell of a string displayed, such as left, right, center, etc., attributes of displayed borders, patterns, and colors of cells, etc.

Cells may be copied, pasted, moved, etc., either into the current spreadsheet or into another spreadsheet, and cells may be inserted into, deleted from, or cleared in the current spreadsheet.

Charts, such as line charts, pie charts, bar charts, area charts, column charts, XY (scatter) charts, radar charts, 3D type charts, etc., based on cell data can be created.

Select cells

A cell, a group of cells, characters in the Edit Line, a diagram, or other objects may be selected as a target for succeeding various commands.

Cells are selected by clicking the mouse (5). If the Control Key is held down while clicking different cells, you split the selection (6). Block cells and ordinary cells can be selected at the same time.

References

The value in a cell may depend on a formula References can be used for making cells depend on formulas in other cells. A reference to another cell consists of information about the coordinates (row and column labels) of the cell in question. References can be made to both ordinary cells and block cells. Hence, block cells and cells in the global area may be interdependent.

Relative or absolute references

Both types of references can be used in 4 ways. The notation A1, $A1, $A$1 or A$1 may be used. The $-sign causes either the row or the column reference (or both) to become an absolute reference.

How to create a three-dimensional block

When a new spreadsheet is to be created, the electronic spreadsheet system initially displays what would appear to be a traditional two-dimensional spreadsheet. The user may then select an area of the two-dimensional spreadsheet and create a block of cells comprising a plurality of layers of cells positioned on top of the selected area. Each layer of cells constitutes a storey of the block. The block is visualized in perspective as cells positioned on top of each other or by displaying a shadow, lines, etc, around the block, so that blocks of three-dimensional cells can be clearly identified by the user (7).

A block may be positioned anywhere in the two-dimensional spreadsheet and may comprise any number of cells. Groups of any number of block cells may be positioned adjacent to each other.

To create a new block,

1. Select the cells in the document where the block is to be created,

2. Click the “New Block” menu command or click the button with the symbol of a block,

3. A dialogue box is displayed,

Enter the number of storeys to be created,

Select the color of the shadow around the block,

Click Include Storey in Calculations if the block cells in the storey are desired to take part in block functions, and

4. Click OK.

The electronic spreadsheet system calculates the block cells just as if they were ordinary cells. Calculations are updated when the user scrolls through the storeys of the block.

Block cells may be identified by rows and columns as for 2D cells plus a third variable in the third dimension. Every storey has a number attached to it (1, 2, 3 . . . ). In this way, the notation of a block cell positioned on the 1st storey at the location B3 would be B3_{—}1 (8), and the notation of a block cell positioned at the same location but on the 2nd storey would be B3_{—}2 (9). The storeys can be named as well.

Several blocks can be created in every document. New blocks are referred to by a block number but a reference name can be used as well.

Stack of block cells

Block cells having identical row and column addresses are said to constitute a stack.

The storey

Cells addressed by as specific value of the third variable are said to constitute a storey. Cells of a displayed storey of the block are displayed in a way similar to that of ordinary cells.

Add Storey

When adding a new storey, a new layer of block cells is created. The new storey has the same number of block cells as the original storey (10), and the position of the new block cells (11) is also the same (i.e. in the second dimension).

When creating a new storey, the displayed storey is changed as the new storey is displayed instead. Normally the new storey contains no data, but the user may choose to copy the contents of an existing storey into the new storey. Further, the user may choose to copy a storey template created earlier into the new storey.

In a dialogue box it must be determined whether the new storey should be included in block functions and criteria may be added to the new storey and the new storey may be given a name.

To add a storey,

1. Select a cell in the actual block,

2. Click the Add Storey menu command,

3. A dialogue box is displayed,

Click the check box Copy template if relevant,

To create a different format, click the “Custom Format” check box. (It copies the displayed storey as default),

Optionally; enter a name of the new storey,

To include the storey in block functions, click Include in Block Functions check box,

Optionally enter criteria, and

4. Click OK.

Location of new storeys

The new storey is placed on top of the block as default, which means that the new storey is assigned the highest storey number+1.

The user may also choose to insert the new storey either at the bottom of the block or before or after the displayed storey. After insertion of a new storey, the remaining storeys are renumbered accordingly.

Number of storeys created in a block

Presently more than 32,000 storeys can be created in a document. New storeys cover the same two-dimensional area as the old ones.

Storey identifier

The storey is automatically assigned a storey number and a name may also be given to the storey. The names of storeys are displayed in the pop-up menu in the upper left corner (12) of the spreadsheet document.

For example, an annual sales budget may comprise 12 storeys, one for each month of the year, and each storey may carry the name of the corresponding month so that a user of the electronic spreadsheet system may easily identify data of a specific storey.

The names of storeys can be changed at any time.

To change the name of a storey,

1. Click the Storey Info menu command,

2. Enter the new name in the text box (13), and

3. Click OK.

To delete storeys,

1. Select the storey to be deleted to be the displayed storey, and

2. Click the Delete Storey menu command.

The block cells on the actual storey of the block are deleted.

To delete a plurality of storeys,

1. Click the Delete Storeys menu command,

2. A dialogue box is displayed,

3. Enter the names or numbers of the storeys to be deleted from the block in the dialogue box or select the storeys in the pop-up menu displayed, and

4. Click OK.

When a storey is created using the Add Storey dialogue box, it can be protected from being deleted later.

Create series in the block

Predefined series of data may be copied into the cells of a stack, e.g. the names of the months, hours of a day or the days of a week can be created in the block. To perform this operation, the user simply has to click the right check box in the New Block dialogue box.

Create a storey template

A storey of cells may be saved as a storey template to be used as a master when a new block or a new storey of an existing block has to be created. The user can choose among the user-defined templates in the Add Storey menu command in the Block menu where the templates are placed in a submenu.

Add block cells to an existing block

To add cells to an existing block (14),

1. Select the ordinary cells (outside the block) to be included in the block in question, and

2. Click the menu command Add Cell to Block.

In this way a stack of block cells is created under any selected cell (15). Hence, every storey in the block obtains the same expansion.

To delete block cells,

1. Select the actual block cells, and

2. Click the Delete Block Cell menu command.

The top cells of the selected stacks are converted into ordinary cells, and the shadow is moved to show that the block is now reduced in size.

If all the block cells are selected and the menu command Delete Block Cell is performed, the entire block will be deleted.

If the stack contained a value in the upper storey, this value is written in the new 2D-cell(s).

To delete a block,

(A block is deleted by turning cells of its top storey into ordinary cells)

1. Click any cell in the block, and

2. Click the menu command Delete Block.

It is a significant advantage of the electronic spreadsheet system that multidimensional cells are treated by the spreadsheet system with the same ease of use as the treatment of two-dimensional cells in known two-dimensional spreadsheets, e.g. the electronic spreadsheet system provides the same user-friendliness when entering data and formulas in three or more dimensions as provided for two-dimensional data and formulas by known two-dimensional spreadsheet systems.

Time e.g. in connection with budget making is saved because category labels and formulas need not be repeated in several documents and because links between documents need not be created.

It is an important advantage of the electronic spreadsheet system that displaying multidimensional data as one or more blocks positioned on a two-dimensional spreadsheet provides a user with a very intuitive perception and overview of data. The combination of the block and the global area offers the advantage of having all relevant information in the same window on the screen. In order to inspect the contents of cells along a third dimension, it is no longer necessary to turn pages of a notebook and thereby losing track of data interrelations, instead the contents of the cells of a block can be displayed without changing position of e.g. 2D-cells with important relations to the data of the block.

As it is possible to operate with several layers of cells in one part of a document and a single layer of cells in another part of the same document, the operation is performed in a real three-dimensional environment, and spreadsheet models can actually be created that could not be made in traditional spreadsheets (in which the third dimension is merely created by placing several 2D-documents behind each other).

As most people find it difficult to make calculations in data bases using a complicated programming language, it is a still further important advantage of the electronic spreadsheet system that it combines the userfriendliness of a spreadsheet with the possibility of storing data in a data base like manner. The user will have no difficulty making calculations using the block in the electronic spreadsheet system.

As the electronic spreadsheet system presently can hold more than 32.000 storeys in every document the spreadsheet may be used for scientific purposes and for storing data even in large companies.

It is easy to create a template for users, such as clients of an accountant, for example, if a budget is created for the month of January by one user, other users can make their own budgets for all subsequent months. They only have to click a single button to add new budgets. Thus, the spreadsheet model can be created and delivered to your clients or customers.

This feature allows an accountant to create a spreadsheet adapted to the needs of a specific group of clients and to transmit a part of the prepared spreadsheet, e.g. comprising a storey, without numerical data but with established formulas and charts to a client The client may then enter his or her data, such as numerical values, into the received part of the spreadsheet and inspect results of calculations and displayed charts based on his or her data. After such a session, the client may transmit the part of the spreadsheet with his data back to the accountant and the spreadsheet system will then enter the received data into the corresponding part of the spreadsheet, such as the appropriate storey for the client in question.

Much time is saved when using the electronic spreadsheet system in order to create spreadsheet models to your clients or customers. Later, when the clients return the documents, the data need not be imported into a data base and the result need not be transferred to a spreadsheet to be able to make the calculations. The contents of all documents is simply imported into a block in the electronic spreadsheet system, and then the data material can be handled immediately.

The electronic spreadsheet system saves memory spending as category labels and formulas on several pages need not be repeated (as would be the case in traditional spreadsheets). The importance of this will increase when creating large spreadsheet models using a substantial amount of storeys. Therefore, when dealing with RAM-spending, the electronic spreadsheet system is superior to that of traditional spreadsheets.

The traditional method of calculating in the third dimension is first and foremost time consuming. First the documents have to be formatted in such a way that they will have the same appearance in all the documents. Then links between the documents must be established, and in many situations a “mother document” should be created which has to get information from those cells in all the documents that should participate in the calculation. For each cell in the calculation the notation has to mention both row- and column coordinates as well as information on the spreadsheet.

Functions and features relating to the block

Top Cell References

In a formula of a cell, references can be made to block cells displayed in the displayed storey of a block. This type of reference is denoted a Top Cell Reference, i.e. the Top Cell Reference only specifies the row and column addresses of a cell. The cell actually used as a data source in the formula will be the cell displayed in the displayed storey of the block and with the referenced row and column addresses. For example, when a Top Cell Reference is made in a formula of an ordinary cell (16), the value of the ordinary cell is calculated from the values of the corresponding block cells displayed in the displayed storey of the corresponding block. Thus, the value displayed in the ordinary cell (17) will typically change when block cells of another storey are displayed (18).

This means that the user would work with cells in the displayed storey of the block just as he would work with cells in traditional two-dimensional spreadsheets. If, for example, the user makes a reference to the cell C5 without entering information about the storey number, he creates a reference to the cell C5, irrespective of the displayed storey. Top Cell References can be used for various purposes.

With Top Cell References it is possible to compare data in the global area (19) with data displayed at the top of a block (20). If the values in the two areas are subtracted from each other, the difference (21) will change, whenever the storey is changed (22).

The result in block cells in a block may depend on values in block cells in another block. Block cells in two blocks may be compared with each other (23) and the result may be shown in the global area (24) or in a third block. A change of storey in one of the blocks will cause a change of the result (25).

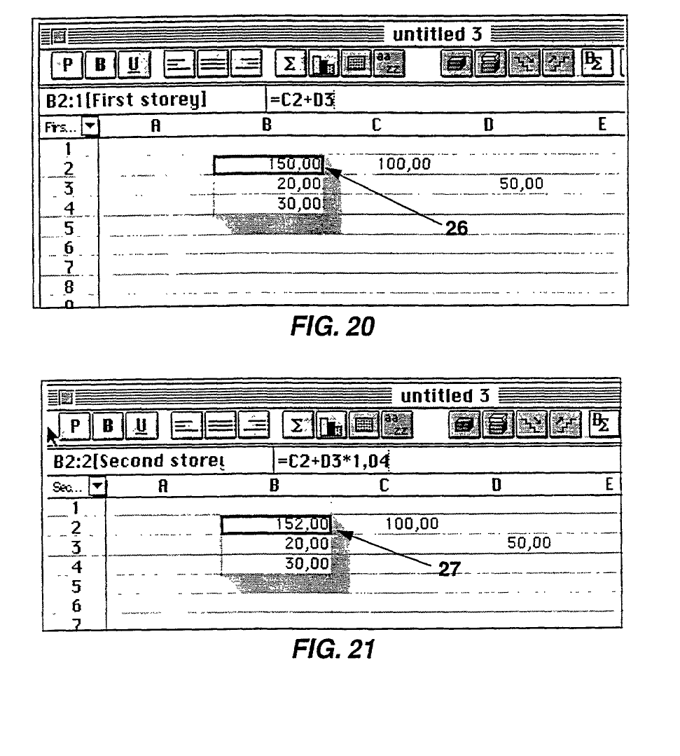

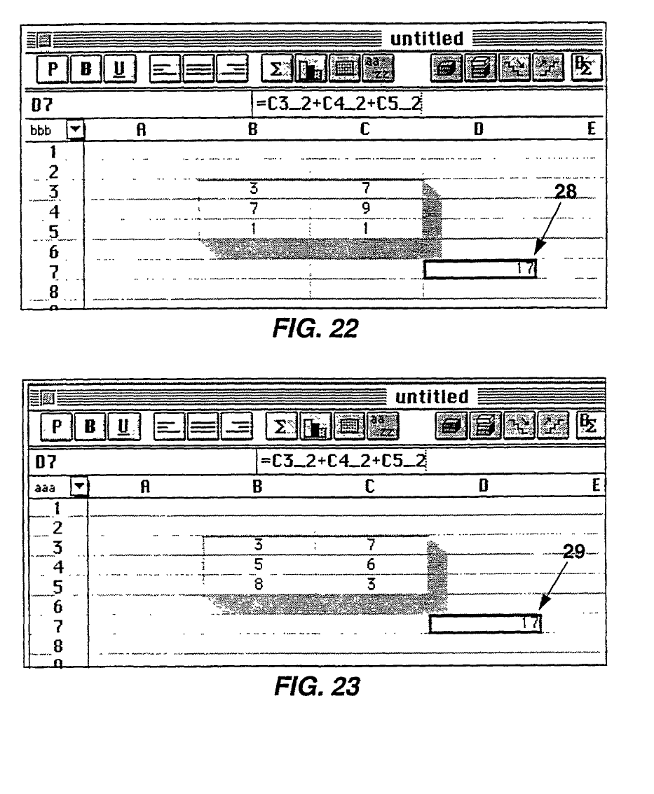

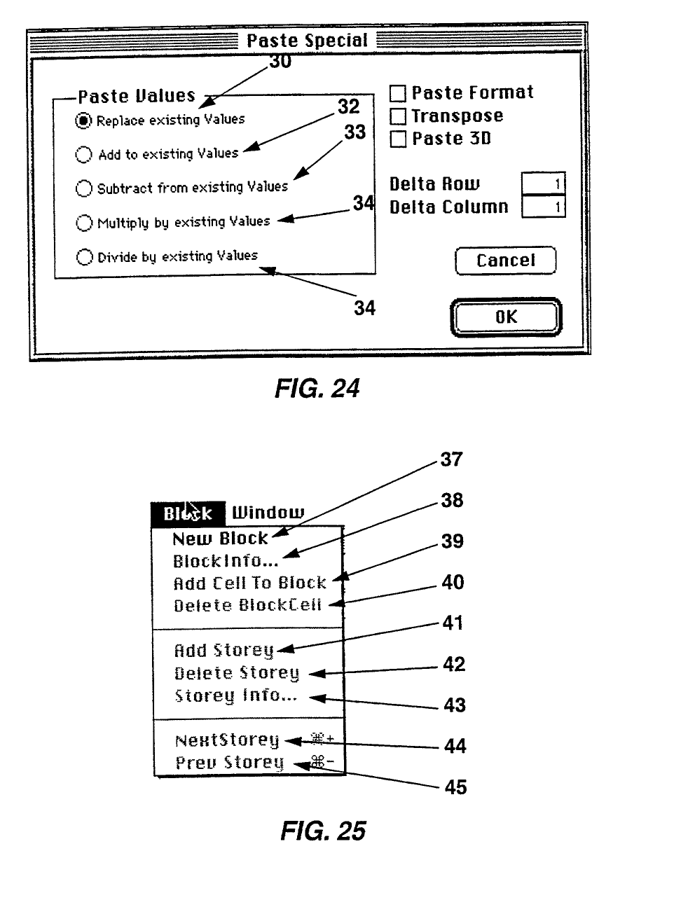

As the values in block cells can depend on the value of cells in the global area, the block may also be used for creating alternative results to mathematical problems. Thus, when the user scrolls through the storeys, he can view different solutions to a problem. In FIG. 20 the result is 150 (26), whereas the alternative solution is easily shown by displaying the second storey (27).

Instead of using Top Cell References, the block cell in question may be referenced. In other words the user may choose whether he desires that the result in cells referencing another cell be changed when the displayed storey is changed.

How to reference block cells

Formulas of a cell may reference any cell of the spreadsheet whether those cells are displayed or not. Thus, the displayed value of such a cell (28) does only change if the value of a referenced cell is changed, which means that a change of storey would not affect the value of the cell in question (29).

Using cell references, numerical values from different storeys in the block can be compared with numerical values in the global area. If the same comparison in a traditional spreadsheet was to be made, the comparison would have to be made on every page, or a new page would have to be made in which references would be made to the actual cells in the other documents.

Formatting of block cells

Formatting of block cells is much more easy to perform than if several documents had to be formatted in a traditional spreadsheet.

Adjustment of font, size of letters, number of decimals etc. in the actual cells in the block is performed as that of the ordinary cells in the spreadsheet.

To format block cells,

1. Select the block cells in the displayed storey, and

2. Make your changes in format by selecting the menu command in question.

All the block cells under the selected block cells are formatted in the same way as the displayed cells. Several stacks of block cells can be formatted at the same time.

Click Block Format if a whole block is to be formatted at the same time. Storeys can be given their own special format with the Storey Format menu command.

Copy and paste

The contents of cells can be moved to a different location in the spreadsheet or to another document or even to another programme by using the menu commands Copy and Paste.

Using Cut, the contents of a cell is moved but not the cell itself. Consequently, there is no need to adjust the contents of other cells using this command. The contents of other cells only has to be adjusted when the user performs the Paste and Clear menu commands in the Edit-menu.

When using copy and paste in cells, the relative references in the pasting-area are automatically adjusted.

If a copied cell is to reference the same cells after the paste command, absolute references should be used.

Copy

The contents of cells can be copied and inserted anywhere in the spreadsheet. When using the Copy command, the contents of the stack is not copied; only the contents of the actual cell is copied.

Copy cells in the displayed storey

The contents (or part of it) of any displayed block cell can be copied and inserted anywhere desired (either in the block or in the global area).

Copy block cells hidden in the block

With Copy Block Cell the block cells of a whole stack can be copied (one or several stacks of block cells are copied).

Paste

The contents of cells, storeys, stacks or blocks can be pasted anywhere into the spreadsheet or into other documents. The contents of a whole block can be pasted if necessary.

Paste in 2D

With the Paste menu command the contents of cells, areas or stacks can be pasted into displayed block cells.

Paste in 3D

To paste the contents of cells into one or several stacks of a block (the third dimension),

1. Select the cell into which the copied cells should be pasted,

2. Click the Paste Special menu command,

3. A dialogue box is displayed,

4. Click the Paste 3D check box, and

5. Click OK.

To paste into more than one stack, select the exact position in which to place the contents of the cell that was placed in the upper left corner of the copied area. Using the Paste 3D menu command, the copied stacks will maintain their positions when being pasted into the new area

If there is no block where the paste command is being performed, a dialogue box will be displayed asking the user whether he wants to paste in 3D or not. If the user answers no, he is asked whether he wants to perform the paste command in the global area or whether he wants to cancel the operation. If he wants to go on, the stacks will be pasted into the global area. If the cells in the new location of the spreadsheet are not empty, he is asked whether he wants to overwrite the cells or whether he wants to push the rows/columns away to make space for the paste command. This command will adjust any reference in the area.

If—on the other hand—the user wants to paste in 3D, he is asked whether he wants to copy into a new block or not. If a new block is desired, it is created. If the user does not wish to create a new block, the block (in which the copy command was performed) will be expanded.

Paste Special

The paste special function includes the following options,

select to paste the formulas and/or the formatting of the copied cells into the new area or if you want just to paste the value of the cells,

select to multiply the contents of the copied cells by the contents of the cells in the new area,

select to divide the contents of the copied cells by the contents of the cells in the new area,

select to add the contents of the copied cells to the contents of the cells in the new area, and/or

select to subtract the contents of the copied cells from the contents of the cells in the new area.

To execute Paste Special,

1. Select the cells into which the contents of the copied cells is to be pasted, and

2. Click Paste Special in the Edit menu,

In the dialogue box displayed,

Click Copy Format to give the target cell or cells the same format as the original cell or cells,

Click Replace Existing Values (30) to replace the value in the target cell or cells with the value(s) from the original cell or cells,

Click Multiply by existing Values (31) to multiply the existing values by the new values,

Click Add to existing Values (32) to add the contents of the target cells to the contents of the original cells,

Click Subtract from existing Values (33) to subtract the values of the original cells from the values of the new cells,

Click Divide by existing Values (34) to divide the cells in the new area by the values of the original cells,

Enter values into the Delta Row and/or Delta Column (35) text boxes if the cell addresses are to be adjusted during pasting (Paste Special with variable Cell Address Adjustment), and/or

Click Paste 3D (36) to paste the contents of the copied cells into one or several stacks.

Paste Special with variable Cell Address Adjustment

With Paste Special with variable Cell Address Adjustment pasting can be performed into both the global area or into stacks in such a way that user-defined intervals are created in the relative row or column references or with intervals in the storey intervals, when pasting into a block In this way, flexible and easily overlooked spreadsheet models both in 2D and in 3D perspective can be created.

The intervals in the relative row or column references need not be of the same size. In this way a so-called “Jumping” Average is created.

Paste into specified cells in the stack

To paste into specified cells in the stack with the Specify 3D-Paste menu command,

1. Click the Specify 3D-Paste menu command,

A pop-up menu is displayed,

2. Select the cells (or storeys) to be the target of the pasting, and

3. Click OK.

How to work with the Fill function in blocks

The contents of one or several cells can be filled into cells of either the global area or into the displayed storey of a block. The operation is performed just as you would perform it in a traditional spreadsheet.

To fill the contents of one or several cells into a stack of a block,

1. Select one or several cells in the displayed storey or in the global area, and

2. Click the Block Fill command in the Edit menu.

The Block Menu

In the Block menu, the most important of the menu commands for use in the third dimension are displayed.

New Block . . .

With this menu command, a new block is created (37).

Block Info . . .

This menu command presents information on the actual block (38).

Add Cell to Block . . .

This menu command adds one or more block cells to a block (39).

Delete Block Cell

With this menu command, one or more stacks of cells are deleted from the block (40).

Add Storey . . .

This menu creates a new storey (41).

Delete Storey

This menu command deletes the displayed storey and the storey underneath is made the displayed storey instead (42).

Storey Info . . .

Information on the displayed storey, e.g. size of the storey, storey number, criteria of the storey is shown upon execution of this command (43).

Next Storey

The storey above the storey currently displayed is now displayed (44).

Previous Storey

The storey below the storey currently displayed is now displayed (45).

How to navigate in the block

The user can go to the next block cell in the block by clicking the menu command Next Block Cell.

Any storey can be displayed. Having selected a specific storey, all the cells of that storey are displayed on top of the block. The user may perform any operation allowed on ordinary cells on cells displayed on top of a block.

The electronic spreadsheet system keeps track of the location of blocks. Whenever the user clicks in a block cell, the spreadsheet knows which block is the relevant one.

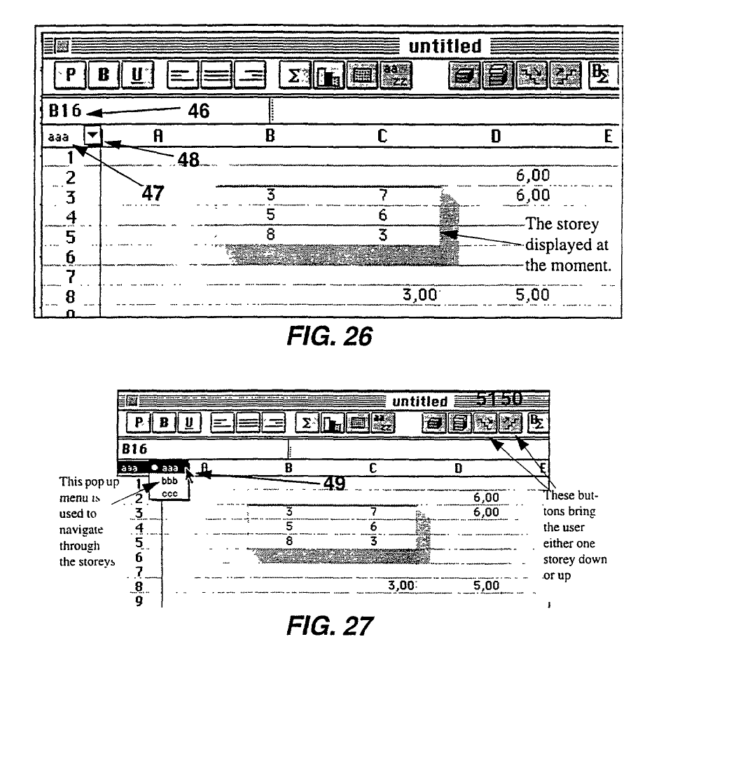

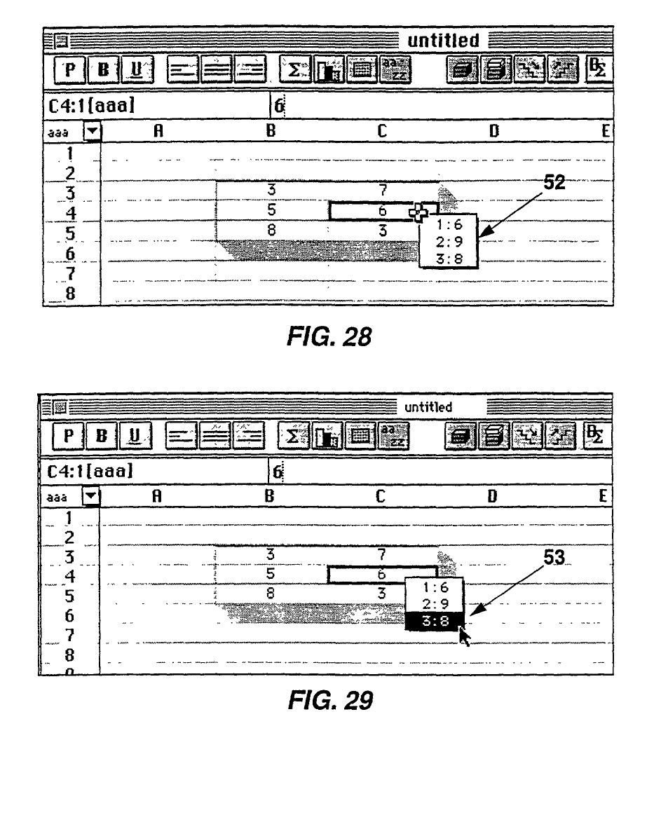

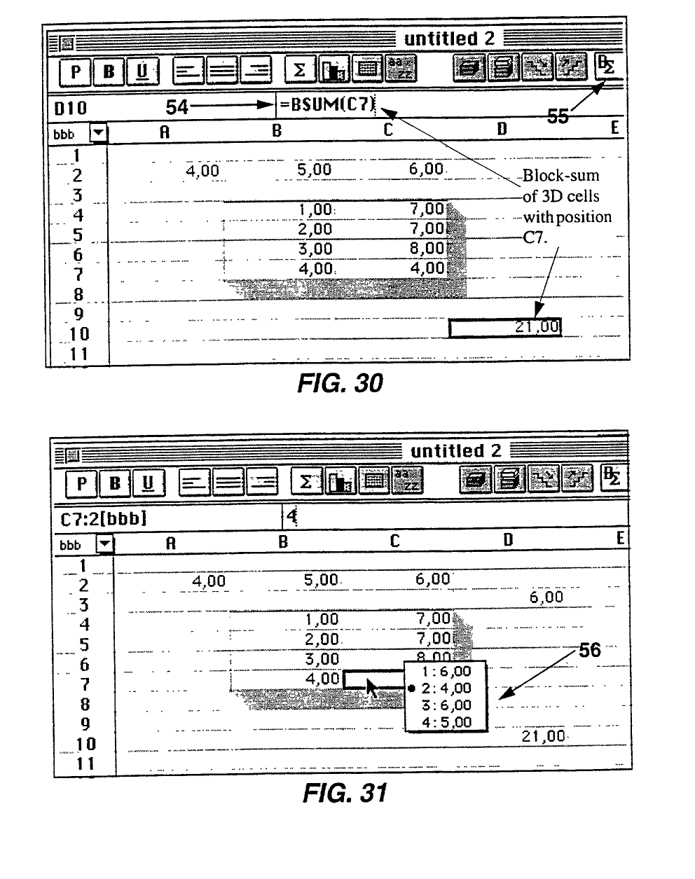

A text box showing the notation of the active cell is always displayed (46). If the active cell is a block cell, the notation will contain three variables. If the cell has a name, it will be written in the text box as the third variable instead of the storey number. In FIG. 26 is shown the current storey displayed and in the upper left corner the name of the storey, “aaa” (47) can be seen.

When operating with figures in several layers, one of the most important advantages of the three-dimensional spreadsheet is that the relevant storey and the exact values or formulas to be worked with will be found very rapidly.

The order of the storeys in the block is not changed by selecting storeys. Every storey still has its original number in the block. When a storey is selected, it is only determined which storey should be the displayed storey.

A plurality of tools are provided for selection of a storey to be displayed at the top of the corresponding block. The pop-up menu, the buttons, the Control key or menu commands can be used for navigating through the storeys of a block. Using these features, the user can move one storey up or down, move to the previous storey, choose to go to the top or to the bottom of the block or move to any desired storey.

In the upper left corner of the spreadsheet, the symbol of an arrow is seen (48). When the user clicks this symbol, a pop-up menu is displayed (49), and he can choose between the storeys by scrolling down the pop-up menu using the mouse until the right storey number is reached. Names of storeys may be written to the left of the storey numbers in the same pop-up menu.

A button is provided, upon the selection of which the storey level of the storey displayed on top of the corresponding block is incremented by one (50), and another button is provided, upon the selection of which the storey level of the storey displayed on top of the corresponding block is decremented by one (51). The same result is obtained by pressing the Command Key while pressing the “+” or “−” sign—or if the menu commands Next Storey or Previous Storey are used.

The cells under the active cell in the block may also be displayed. When the active cell is clicked while the Control Key is pressed, a pop-up menu showing the values in all the cells in the actual stack is displayed (52), and any storey can now be selected to be the displayed storey (53).

To Step through Block,

1. Click the Step through Block menu command,

In the dialogue box is displayed,

Enter a value in the text box to step through storeys of a block by incrementing or decrementing the storey number of the displayed storey by the selected integer,

Click Step through same Format to step through storeys with the same formatting as the displayed storey, and

2. Click OK.

Scenario

To record the order in which a number of storeys are displayed for later playback upon execution of a corresponding command,

1. Select a cell in a block,

2. Click Scenario,

A dialogue box is displayed,

3. Enter the storey identifiers in the order in which the storeys are to be plaid back, and

4. Click OK.

Move Storey

The positions of storeys in a block may be changed.

The Move Storey menu command cuts one storey out of the block. The storey can now be placed elsewhere in the same block.

To move a storey within a block,

1. Click the Move Storey menu command,

A pop-up menu showing all the storeys is displayed,

2. Select the storey that is to be moved,

3. Drag the storey to the new location, and

4. Click OK.

Move Block

To move a block from one position on a spreadsheet to another position,

1. Click anywhere in a storey belonging to the block,

2. Click the Move Block menu command, and

3. Drag the block into a new position.

References in formulas will be adjusted accordingly no matter whether these references are absolute or relative references.

If the user desires to move part of a block, he selects the stacks to be moved and clicks the menu command Copy Stack.

Select Block

Use the Select Block menu command to select a whole block (first, a cell in the actual block should be selected).

Show Stack List

Having selected a block cell, the stack of block cells may be displayed underneath the selected cell,

1. Select a block cell, and

2. Click the menu command Show Stack list.

A list showing all block cells in the stack under the selected cell is shown from the left to the right at the bottom of the spreadsheet.

When another block cell is selected, the corresponding list of block cells is shown instead of the original one.

Show Stack List is turned off by selecting it a second time.

The list may also be printed.

To Compare Stacks,

1. Select at least two block cells, and

2. Click the menu command Compare Stacks.

The stacks of the selected block cells are displayed as a list of data side by side in a horizontal pop-up menu from the left to the right The pop-up menu can be moved on the screen.

If a name of the top cell (in the stack) is used as a stack identifier, the name will be displayed to the left of the corresponding cells in the list (as a category label).

Selection

Storeys can be specified to be shown as a selection. Having performed the Selection command, only the selected storeys can be displayed and operated upon,

1. Click the Selection menu command,

2. A pop-up menu is displayed showing all storeys in the block,

3. Click the storeys to be selected, and

4. Click OK.

Now, the pop-up menu shows only the selection of cells and the block is reduced accordingly.

It is also possible to decide whether the storeys to be seen in the selection should be included in block functions or not,

1. Click Calculate only selection in the above-mentioned pop-up menu, and

2. Click OK.

Upon execution of the menu command Show All, all storeys may be displayed again.

Prevent storeys from being displayed

Execution of the Hide Storey command marks the currently displayed storey which can no longer be displayed. The Show Storey command removes the mark created by execution of the Hide storey command.

To execute the Show Storey command,

1. Click the Show Storey menu command,

2. All hidden storeys are displayed in a pop-up menu,

3. Click the storey or storeys in question, and

4. Click OK.

Change layout

Overlaid Storeys

Upon execution of the user command Overlaid Storeys the storeys of a specific block are displayed as overlaid two-dimensional spreadsheets so that a specific storey can be identified with the mouse. The identified storey is displayed on top of the overlaid spreadsheets. The order of the storeys is not changed when in the storeys are clicked.

Side by Side

The menu command Side by Side shows selected storeys of a block displayed in a two-dimensional format side by side.

Normal Layout

When clicking this menu command you return to the original layout of the spreadsheet.

Control blocks with commands

The storey to be displayed can be selected in a specified block with built-in functions. If you e.g. want storey 10 in block 2 to be the displayed storey whenever a specified storey in block 1 becomes the displayed storey, “Show storey 2_{—}10” need just be written in the actual cell in block 1.

Furthermore, the system can be extended to show a specified storey in a-specified block whenever a specified value is obtained in a certain cell.

Interconnections between blocks

Parallel display

In documents comprising two or more blocks, it is possible to establish display interconnections between some of or all the blocks so that the same storey level is displayed in the blocks between which the interconnections have been established.

To establish such an interconnection,

1. Click the menu command Parallel Display,

2. Enter the identifiers of the blocks in question, and

3. Click OK.

Display Interconnection

Further display interconnections may be established between blocks so that the storey level displayed in one block is an integer multiple of the storage level displayed in another block.

To establish such an interconnection,

1. Click the menu command Display Interconnection,

2. Write the numbers or the names of the blocks in question, and

3. Click OK.

Functions

Creation of formulas

A formula is built by writing it into the Edit Line or by clicking the function in the Functions menu and the cells to include in the calculation.

In cell references, names of cells, storeys and blocks can be used.

When calculating in the block, it is possible to choose between traditional functions and the time saving block functions.

Ordinary functions

Normal functions can be used when referencing block cells in a traditional manner.

In this way, a formula “=SUM(A3_{—}1:H7_{—}123)” will add all the cells in the area A3:H7 in the first 123 storeys. If part of the area is outside the block, the function will also just include the values from these cells.

In formulas, storeys may be referenced both by names or storey numbers. It may be advantageous to reference storeys by names as names are not changed by deletion of storeys in the block or by insertion of new storeys in the block.

In traditional spreadsheets, calculations in the third dimension are performed by linking several documents together by formulas. This means that formulas have to include information on both the cells and the documents performing the third dimension. In the electronic spreadsheet system this method can also be used but as the procedure has several disadvantages, it is suggested that the new block functions be used instead.

Block functions

The intuitive way of calculating data known from traditional spreadsheets, such as summing data along a row of cells or along a column of cells, is transferred to data in three dimensions so that summing data along storeys is carried out in a similar manner. With the block functions, calculations in the block can be made (obtain the average, sum, minimum maximum) with only one click with the mouse. Thus, it is no longer necessary to create complex formulas or links between 2D spreadsheets to make calculations in three dimensions.

An example could be “BLOCK SUM”. As a prefix, the function has a “B” for indicating that it is a block function and in the menu command, the function is therefore written as BSUM. The function adds all values in block cells with the same first and second coordinate in the block.

To place the result (of a block function) inside the block,

1. Select one or more stacks of cells, and

2. Click the block function,

The user would then only have to make sure that the first storey is not included in block functions (normally he would have taken care of this when creating the block).

Placing the result in the global area

If the result of a block function is to be placed in a cell in the global area, the formula including the reference to the block cell should simply be entered into the actual cell in the global area.

If there is more than one block in the document, the user just have to use the normal references because the location given in the reference will indicate which block holds the block cell in question.

The summation of numerical values of the block cells with the notation C7 is specified as BSUM(C7). If the sum of all block cells with the first coordinate C and the second coordinate 7 (building the two-dimensional notation C7) is to be placed in cell D10 (in the global area), the user just have to select the cell D10 should simply be selected, the formula “=BSUM(C7)” should be written in the Edit Line (54) and the result is written in the cell with the notation D10. Instead of writing the formula, the menu command BSUM could be clicked or the button named “BΣ” (55) could be clicked.

FIG. 31 illustrates the values of the stack in question to show the correctness of the calculation (56). In this way, the values in the third dimension can be added by a single click with the mouse and when new storeys are added, formulas or links in the block need not be updated no matter where the new storeys are placed.

BSUM is just one of the block functions in the electronic spreadsheet system. All known functions can be implemented in the spreadsheet.

Decide which storeys to include in calculations

When new storeys are created, it is possible to decide whether they should participate in block functions or not. Click the check button Storey Included in calculations in the New Block dialogue box.

If the user wants to change this calculation mode after having created the storeys, he simply opens Storey Info by clicking the Storey Info menu command and clicks the check button Storey Included in Calculations.

If only specific storeys are to be included in a calculation, the time saving block function can be used or a normal function can be used and the storey level for every cell to be included in the calculation can be specified (as in traditional spreadsheets).

If the normal functions are used, storey levels must be included in the reference, and the references to the storey levels would have to be updated whenever changes were made. Therefore, block functions would be a better solution in this case.

However, in some special situations it would be desired to use normal functions when working with blocks. If e.g. in a block in which a number of storeys are not presently included in block functions, it is desired to include all storeys in the actual calculation, a normal function should be used.

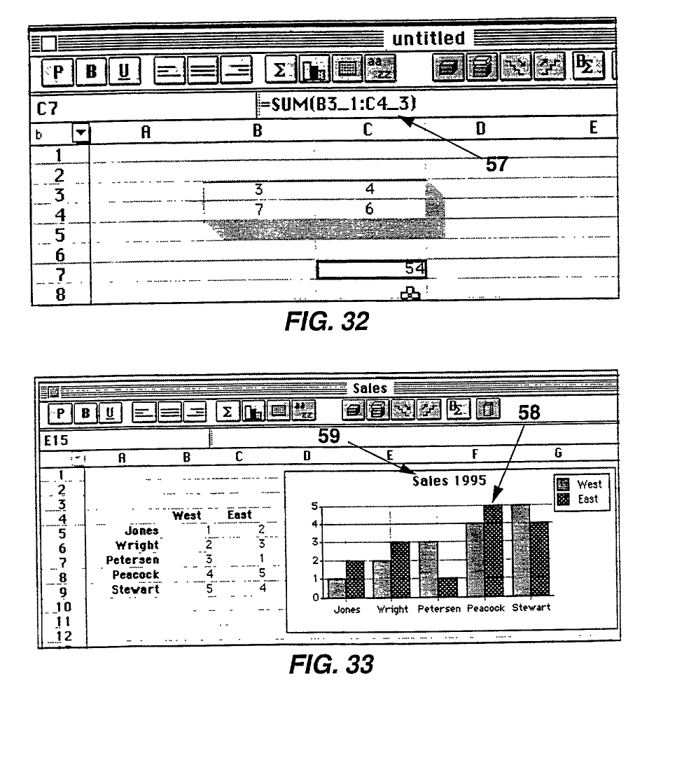

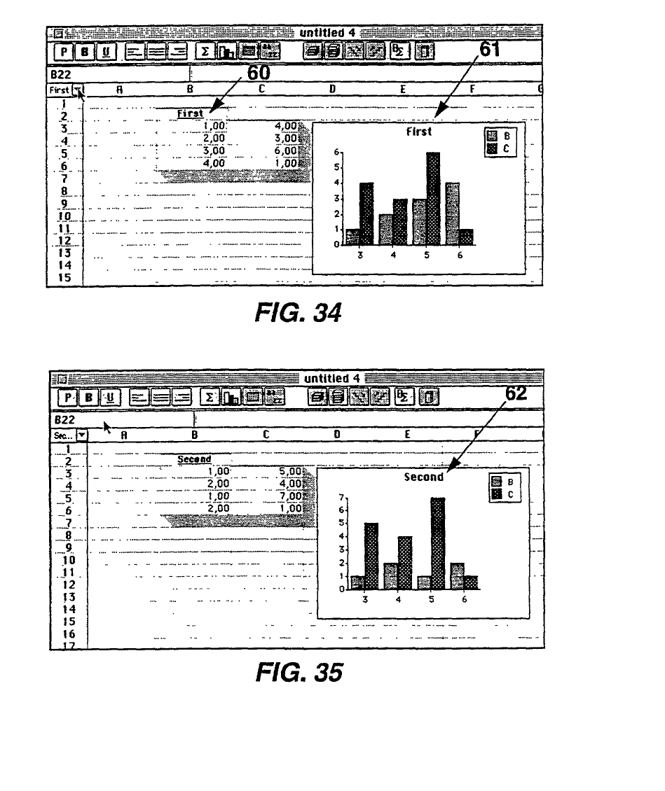

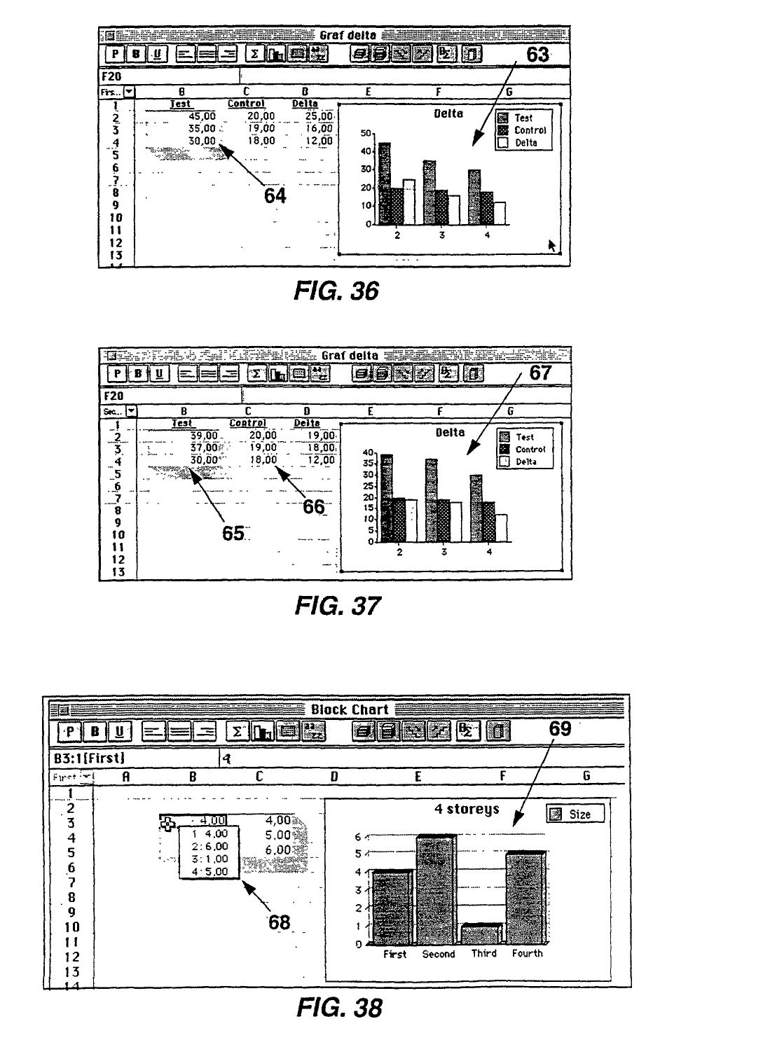

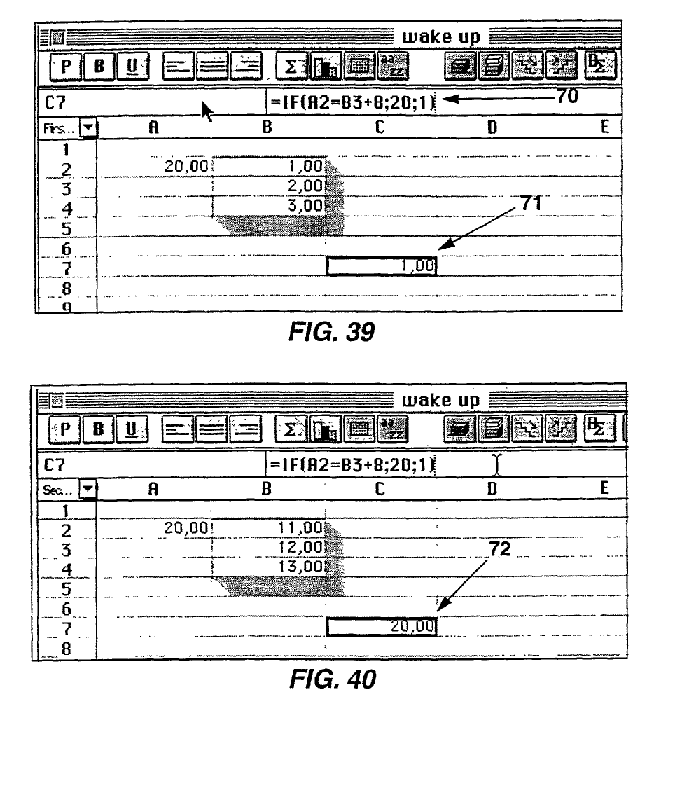

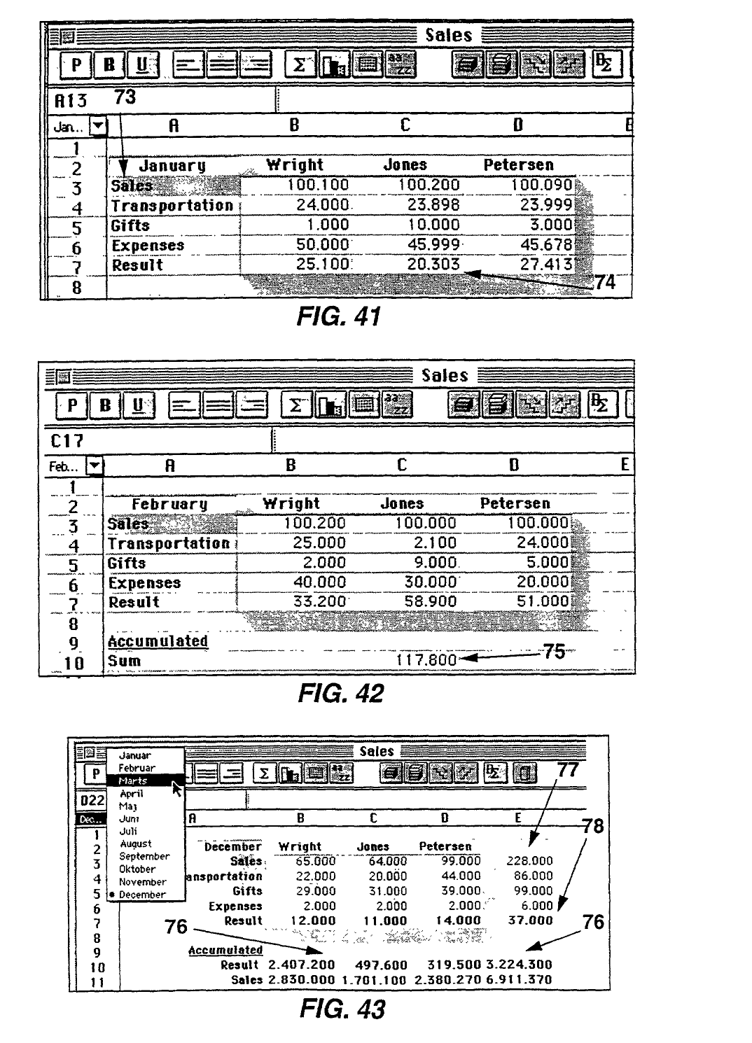

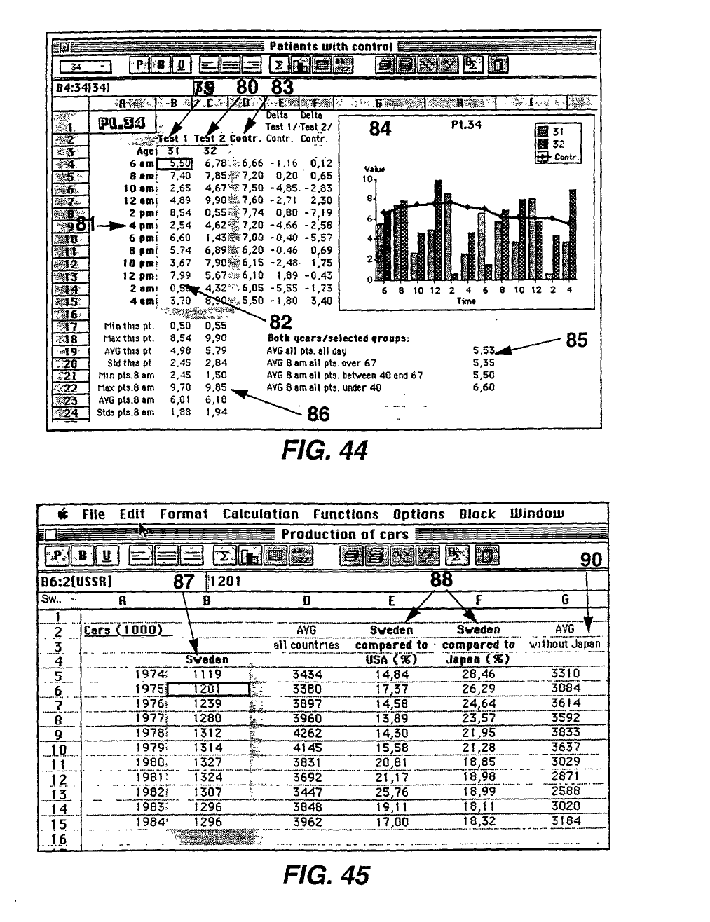

FIG. 32 shows the cells from B3 on the first storey to C4 on the third storey being added to each other, the result being written in cell C7. The formula in the cell C7 is a normal sum-function (57), and it is therefore different from a block function.

Most often, calculations in the third dimension can be performed both more rapidly and easily with the new block functions.

Block Criteria Functions

Criteria should be used if values from certain storeys are needed in some calculations and values from different storeys are to be used in other calculations.

If no criterion is written in the formula, all the cells in the block cells will be included in the calculation.

When one or several storeys are created, a criterion can be written in the dialogue box. The new storey(s) is/(are) then given the criterion.

Attaching Block Criteria to a storey

The user can specify whether or not the storey currently displayed is of a specific kind, e.g. whether or not it is relevant as a source of input data for specific formulas, e.g. block functions.

To attach a block criteria to a storey,

1. Click the menu command Criteria,

A dialogue box is displayed,

2. Enter the criteria, and

3. Click OK.

To Attach Block Criteria to a plurality of storeys,

1. Click the menu command Distribute Criteria,

A dialogue box is displayed,

2. Enter the criteria in the text box,

3. In the pop-up menu click the storeys that should be given the criteria, and

4. Click OK.

An example

Assume that 12 reports regarding the sales last year are vested in a block and it is now desired both to add the sales from all the months and to obtain the average of every second months.

The problem is solved by using Block Criteria Functions by means of which it is decided which storeys should deliver data to the calculation. In this way, the same block may be used for different calculations.

To obtain the sum of the sales for all the months, the BSUM function should simply be performed, which means that all storeys would participate in the calculation.

To obtain the average, a criterion would be attached to the actual storeys e.g. “G”. Then the average of the storeys is calculated with a “G” attached to them. The formula to be used would then look as follows: BSUM(G).

Combine criteria

A block calculation may reference one or more various criteria for inclusion or exclusion of data of a specific storey in the calculation.

If a block contains information relating to medical test results of a number of patients and each storey of the block contains data of one patient, averages may for example be calculated for a group of specific patients defined by attributes specified in the above-mentioned dialogue boxes relating to the storeys.

A summation of numerical values of a stack of block cells may be specified as “BSUM(A4;[criterion A; criterion B])” which sums the numerical values of cells in the stack at the address A4 of storeys fulfilling both criterion A and B.

To Change Criteria,

1. Click the Change Criteria menu command,

A dialogue box showing all storeys with all attached criteria is displayed,

2. Change the criteria, and

3. Click OK.

Criteria can also be deleted using this pop-up menu and criteria may even be deleted in several storeys at the same time.

An example of the use of criteria

Typically, many companies store data in data bases and make the calculation on the data in spreadsheets, but as the block in the electronic spreadsheet system is able to contain more than 32,000 storeys, it is possible to store all relevant data in the same block—and as it is very easy to calculate using criteria, different calculations can be performed using the same data material in the block. Therefore, you can work with the block in much the same way as you would work with a data base, but the most important thing is that calculations can be made as easily as if you were in the 2nd dimension in any other spreadsheet.

Hence, the electronic spreadsheet system can be used for storing data in e.g. companies in the financial sector, or by scientists or doctors. In this way, a doctor can store information about all her patients in the same document Using Block Criteria Functions, the doctor can store all her data in the same place (the block) and use the electronic spreadsheet system to all his tests.

It is important to notice that the Block Criteria Functions include all storeys with the right criteria. This means that the tags which in general determine whether storeys should be included in block calculations or not do not exert any influence on Block Criteria Functions.

Traditional use of criteria

When using criteria in the traditional way, cells are referenced (not only storeys as when you are using the block functions).

The formula “=CSUM(A4;C5;TRUE)” adds all the block cells having the notation “A4”, which fulfil the criterion after the “;”-sign.

Criteria can also be used in the global area.

Find

The menu command Find in the menu Options is used for finding a cell containing a specific text string.

To find a specific text string,

1. Click Find in the menu command Options,

2. Enter the text string in the Find dialogue box, and

3. Click OK.

Using this menu command, both the blocks, and the global area are searched for the text string. When the text string is found in a block, the actual storey will be shown.

Find in block

A block may be searched for specific data with the menu command Find in Block. The procedure is the same as for Find. Only the specified block will be subjected to search.

Include storeys in searches

When creating storeys the Include Storey in Searches check box is used if the storey is to be included in searches.

Block Criteria Find

In the Find in Block menu command, the criteria can be written together with the text string searched for.

To search for the text string in storeys with fulfilling a specified criteria,

1. Enter the criteria in the text box in the Find in Block menu command, and

2. Click OK.

Find next

This menu command is used for finding the next occurrence of the word. Information about the block

Storey Info

Information about a selected storey, such as its identification, storey level, number of cells, etc., is available by selecting Storey Info.

If a Storey Info is displayed on the screen, the Storey Info of the next storey is presented when the right arrow key is pressed and the Storey Info of the previous storey is presented when the left arrow key is pressed.

Block Info

Information about blocks, e.g. number of cells, number of storeys, the name of the block cell formats, a list of the areas that the block covers, etc., is displayed upon user selection by selection of the menu command Block Info.

Show all informations

A list of all Block-Info windows, all Storey-Info windows is generated. The list can be printed.

Diagrams

The electronic spreadsheet system comprises means for graphically displaying data values of selected cells.

To create a diagram,

1. Select the area that holds the data to be illustrated, and

2. Click the menu command Make Chart in the menu Options or click the button with the symbol of a diagram.

How to illustrate displayed block cells

The values in block cells can be illustrated in a diagram in the same manner as values in ordinary cells. The block cells are selected in the same way that cells are selected in the global area, and the diagram is created exactly as a diagram would be created in the global area. Thus, when the displayed storey is exchanged with another storey, the chart will change accordingly.

Title of Diagram

A title can be added to a diagram by entering the title into the text box of the Chart Info box (59).

How to make the title of a diagram change when changing storey

If a text string e.g. the name of the displayed storey is entered into one of the block cells (60) and at the same time a two-dimensional reference to that specific location of the block is also entered into the title box of the Chart Info, the name of the storey will be written at the top of the diagram as a title (61), and the title of the diagram will always reflect the name of the actual displayed storey (62).

When comparing data of the displayed storey with data of the global area by subtracting the values of the two areas from each other, a diagram may be made showing the result of the comparison (63). Thus, when the displayed storey (64) is exchanged with another storey (65), the chart showing the result of the comparison (66) and the diagram (67) will change accordingly.

How to illustrate block cells not displayed

It is also possible to create a diagram showing values of block cells not displayed at the moment. This is called Block Chart. As is seen (from the pop-up menu) in FIG. 38, the values of the third dimension of the block cells with the two-dimensional notation B3 are 4, 6, 1 and 5 (68) and, accordingly, these values are shown in the Block Chart (69).

To create a Block Chart,

1. Select the block cell under which the stack of cells to be illustrated is positioned, and

2. Click the menu command Block Chart or click in the button with a symbol of a block chart.

Block Criteria Chart

To specify criteria for inclusion or exclusion of data from cells of a given storey in the chart,

1. Click Block Criteria Chart,

A dialogue box is displayed,

2. Enter the criteria of the storeys to be included in the chart, and

3. Click OK.

How to change a plotted chart

When values of cells being plotted in a chart are changed, the diagram is changed accordingly.

How to sort data in the block

Data may be sorted in the spreadsheet in either alphabetical or numerical order with the menu command Sort.

Data may be sorted in increasing or decreasing order.

To sort data in specific areas,

1. Select one or more areas,

2. Click the Sort menu command,

A dialogue box is displayed,

3. Click Increasing Order or Decreasing Order, and

4. Click OK.

Sort in Block

Storeys of a block may be sorted according to the contents of cells of a selected stack or by using the names of storeys. Sorting of cells in a stack is denoted Block Sort.

The sequence of storeys of the block is either rearranged as a result of the sorting operation, or, only the cells sorted are rearranged while the sequence of storeys remains unchanged whereby each sorted cell is entered into the appropriate storey fitting the sorted sequence of the cells.

To sort data in a block,

1. Select the block cell on top of the stack to be sorted,

2. Click the Block Sort menu command,

A dialogue box is displayed,

3. Click Increasing Order or Decreasing Order, and

4. Click OK.

Sorting keys

When using the menu command Sort in the menu Options, a plurality of sorting keys can be specified.

Block Criteria Sort

Various criteria may be referenced in a block sort command in a manner similar to the criteria used in calculations. When using Block Criteria Sort, only storeys fulfilling criteria specified in the Block Criteria Sort will be sorted.

To use Block Criteria Sort,

1. Select the block cell on top of the stack to be sorted,

2. Click the Block Criteria Sort,

3. Click Increasing Order or Decreasing Order,

4. Enter the criteria to determine which storeys should participate in the sorting, and

5. Click OK.

Protection

The contents of cells, storeys, stacks and blocks can be protected. More storeys can be protected with one command and the protection of a plurality of storeys can be cancelled with one command.

Hide storeys

To mark storeys for not being displayed during a session of stepping through storeys of a block,

1. Click the Hide Storey menu command,

2. A pop-up menu is displayed,

3. Select the storeys to hide (optionally with a code), and

4. Click OK.

Hide block

To mark blocks for not being displayed by displaying the cells of the displayed storey as ordinary cells,

1. Click the menu command Hide Block,

A dialogue box is displayed,

2. Enter the code, and

3. Click OK.

When the code is stated, the rest of the block is displayed again.

It is advantageous to be able to hide the block, if it contains critical information.

Write Protection

To protect contents of cells or groups of cells so that the contents cannot be changed until the protection is removed,

1. Select a cell or a group of cells,

2. Click the menu command Write Protection,

3. A dialogue box is displayed,

4. Enter the code, and

5. Click OK.

To protect cells in a block,

1. Select the cells to be protected,

2. Click the menu command Cell Protection in the Format menu,

A dialogue box is displayed,

3. Click in the check boxes Locked or Hide Cells,

4. Enter the code, and

5. Click OK.

Hide the Edit Line

To mark the Edit Line for not being displayed so that data entered into a cell is not displayed in the Edit Line,

1. Click the menu command Hide Edit Line . . . in the menu Options,

2. A dialogue box is displayed,

3. Enter a code in the text box, and

4. Click OK.

Several Global Areas

One spreadsheet document may comprise a plurality of global areas to be used with a common set of multidimensional data displayed one at the time.

A large set of multidimensional data may be used for many different purposes and it may be an advantage for the user having finished one set of investigations and calculations on such a data set to be able to start a new set of investigations and calculations in a new global area in the same screen view in which the block is positioned. This corresponds to start new calculations on a clean sheet of paper using paper and pencil.

The contents of cells of a global area e.g. a data value, a text, a format specification, a formula, etc., or any combination hereof, may be stored.

Also, various scenarios may be performed by scrolling through separate global areas.

How to link spreadsheets

Spreadsheets may be linked together in the manner in which a traditional spreadsheets would be linked together. If there are no blocks in the documents, the notation could be e.g. A:A1+B:C3. If blocks are included, the notation could look as follows: A:A1_{—}4+B:C3_{—}3.

Print

A document, part of a document or a diagram can be printed. The menu commands in the Options menu are used for determining page breaks, printing areas, etc.

To print a document,

1. Select the menu command Print in the menu File,

2. Click the various options, and

3. Click OK.

To print part of a document,

1. Select the area,

2. Click the Print selected Area menu command in the File menu, and

3. Click OK.

Print storeys

You can print a single storey, several storeys or all storeys in a block. The storeys will be printed in numerical order.

Print Displayed Storey

Follow the same procedure as under Print Document or under Print part of a Document

To print a block,

1. Select a cell in the actual block,

2. Click the Print Block menu command, and

3. Click OK.

To Print Storeys,

1. Select the Print Storeys submenu command in the Print menu command,

A pop-up menu is displayed,

2. Click the storeys to be printed,

3. Click the Print together with global area if it is desired to print the global area as well, and

4. Click OK.

Block Criteria Print

Various criteria may be referenced when the storeys to be printed are determined (similar to the criteria used in calculations). When using Block Criteria Print, only storeys fulfillng criteria specified in the Block Criteria Print will be printed.

To use Block Criteria Print,

1. Click Block Criteria Print,

2. A dialogue box is displayed,

3. Enter the criteria, and

4. Click OK.

Only the storeys fulfilling the specified criteria will be printed.

To print storeys and diagrams,

1. Select the diagram,

2. Click the Print Block menu command,

3. A dialogue box is displayed,

4. Enter the block number from which the storeys should be printed,

5. Click the Print all Storeys button or determine which storeys should be printed in the pop-up menu, and

5. Click OK.

Print Report

To print the contents of block cells as reports,

1. Select the block cells to be included in the report,

2. Click the Print Report menu command,

3. Set up the report, and

4. Click OK.

Only the cells selected are included in the report. The Print Report menu command may for instance be used when a list of customers in the block is needed, but at the same time some of the cells contain irrelevant information or if the cells of the actual block are scattered around the spreadsheet.

How to store data in the block

Several features help the user to store data in the block and to quickly find it again—but most important of all; calculations can be made using the data from the block as input instead of transferring data from the data base to the traditional spreadsheet in order to perform the same calculations.

How to assign a storey a unique name

Storeys may be assigned unique names. This means that two storeys in the same block cannot be given the same name.

To assign a storey a unique name,

1. Select the storey in question for display,

2. Click Storey Info,

3. Click the Unique Name check box, and

4. Click OK.

To give a block cell a unique content,

1. Click the block cell in question,

2. Click the Unique Cell menu command, and

3. Click OK.

The Unique Cell menu command may be used in order to prevent two block cells in the same stack from holding the same text string.

Data base display

A more data base like display containing fields instead of the grid cells can be obtained upon the Show Record menu command. The user selects the cells to be shown as fields for entering data. In this way, all formulas and irrelevant information are not shown in the records. The storeys can be given both “OK” and “Cancel” buttons for use when entering data into the block. When the Tab key is clicked, the next field of the record will be selected for entering data

“Look up Function”

A “Look up Function” is available. For example when a number of an item in the stock is entered into a cell, the “Look up function” will find the price and text regarding this item in another block and write it in a specified cell.

First, the Look up Area must be created and all numbers of items on stock must be entered.

In this way the block can be used e.g. for writing invoices. Every new storey is a new invoice and the user only has to write the item number to have the price and description automatically filled into the invoice. The number of the item is used for finding the right storey in the other block (the Look up Area) and the text is then found on the actual storey.

The Look up Function can be used in order to look up all sorts of data. If the user e.g. enters the telephone number of the customer, the address, terms of payment, etc. may be filled into the invoice.

Search keys

Search keys can be saved and reused.

Choice List

Cells can be defined to accept only specified text strings. These are called Choice List.

Boolean fields

Cells in the electronic spreadsheet system can be formatted to hold only a yes- or no value. This is called boolean fields.

Mandatory fields

Cells can be formatted to be mandatory. This means that the user cannot leave the storey before he has filled in the cell.

Use of interconnection when working with data

Blocks may be related to each other in such a way that a certain storey in another block is displayed when a specific cell in the current block is selected. Cells of various blocks of the spreadsheet system can be related to each other in a similar way.

IF Sentences

IF Sentences can be used in the global area and in the block IF Sentences mostly work in the same manner as in other spreadsheets (only the storeys have to be referenced), but they offer an opportunity of giving life to the spreadsheet.

Using IF Sentences, the spreadsheet can be caused to make certain calculations when specified values appear in the displayed storey or when statements are either TRUE or FALSE.

### EXAMPLES

“=IF(A1_{—}2=B9;1;-10)”

If the value of block cell A1_{—}2 is equal to that of cell B9, then return “1”. Else return“−10”.

“=IF(AND(A1=B10_{—}3;1=A2);1;0)”

If the value of cell A1 equals that of block cell B10_{—}3 and at the same time it is true that the value in cell B1 is equal to that of cell A2, then return 1. Else return 0.

“=IF(OR(A1_{—}7=A2;B1=A2);1;0)”

If either cell A1_{—}7 is of the same value as cell A2, or the value of cell B1 is equal to that of cell A2, then return 1; else return 0.

“=IF(NOT(A1=A2);1;D1_{—}4)”

If the value of cell A1 is different from the value in cell A2, then return 1. Else return the value of cell D1_{—}4.

“=IF(A2=(B11_{—}2+8);1;20)”

If the value of cell A2 is equal to the value of cell B₁₁_{—}2+8, then return 1. Else return 20.

IF Sentences used together with Top Cell References

When using the IF Sentences in the block in a special manner, a special interconnection between the block and the IF Sentence can be obtained. If Top Cell References are used in IF Sentences (without stating a storey number), IF Sentences can be caused to “wake up” at the moment the storey in which they are located is displayed.

With Top Cell Reference, it can be arranged for IF Sentences in the global area to get “new life” whenever a specific storey is displayed. In this way, very complex spreadsheet models can be built in a simple manner.

For example, an IF Sentence (70) may cause a certain value to be written in a cell when a certain storey is displayed (71) and another value to be written when another storey is displayed (72).

Import

Documents may be imported into the electronic spreadsheet system.

Import notebook, workbook, etc. into the block

Each page of a document may be entered into a specific storey of a block. If a storey is too small to receive a document, the corresponding block is automatically enlarged by adding new stacks to the block.

Import several documents into the block

Each document may be entered into a specific storey of a block. If a storey is too small to receive a document, the corresponding block is automatically enlarged by adding new stacks to the block.

Export

A block, a stack, a storey, a global area or an entire document can be exported.

To use Export Document,

1. Click the menu command Export,

2. Click the check box Export Document, and

3. Click OK.

To export part of a document,

1. Select an area of the document,

2. Click the menu command Export,

3. Click the check box Export Selected Area, and

4. Click OK.

To use Export Storeys,

1. Click the menu command Export,

2. Click the check box Export Storeys,

A pop-up menu showing all storeys is displayed,

3. Click the storeys to be exported, and

4. Click OK.

to use Export Block,

1. Click the menu command Export,

2. Click the check box Export Block, and

3. Click OK.

Multidimensional Runtime Version with export/import facilities

Part of an electronic spreadsheet system document including a set of cells can be transferred, e.g. through a network, via a movable storage medium, etc., in such a manner that the receiver of the document can read, change and/or recalculate (runtime version) the contents of the cells—without necessarily having a version of the electronic spreadsheet system on the computer. Having worked with the runtime document, the receiver may transfer the updated contents of the cells back to the mother program.

This feature allows an accountant e.g. to create a spreadsheet document adapted to the needs of a specific group of clients and to transmit the spreadsheet document without numerical data but with established formulas and charts and transmit part of the prepared spreadsheet, e.g. comprising a storey, to each client.

Each client may then enter his or her data, such as numerical values, into the received part of the spreadsheet and inspect the results of calculations and displayed charts based on his or her data.

Following such a session, the client may transmit the part of the spreadsheet with his data back to the accountant and the spreadsheet system will then enter the received data into the corresponding part of the spreadsheet, such as the appropriate storey for the client in question.

Calculate using storey numbers or storey names

The spreadsheet can calculate using references to the storeys. For example “=1. storey−2. storey+4 storey” would subtract the values in the 2nd storey from the values in the 1st storey and then add the values in the 4th storey to the result.

Make references to rows or columns

It is possible to make references to rows or columns in formulas. The first row in the spreadsheet could be referenced “A” and the second row could be referenced “B”, etc. The first column could be referenced “1” and the second column could be referenced “2”.

Special row and column functions can be performed. For example all the values in row 2 are summed using the expression “RSUM(2)” and all the values in row 3 are summed using the expression “CSUM(3)”.

A whole row or column in a particular storey may be referenced in the same way. If e.g. all the block cells in row A on the 5th storey are to be referenced, it will only be necessary to write “A_{—}5”.

Electronic Expert Systems

Furthermore, the spreadsheet system may be adapted for use in an electronic expert system in that the rules of the expert system may be implemented using the search, sorting, calculation, etc., features of the spreadsheet and the data base of the expert system may be implemented by storing data from its data base in storeys of blocks as described above.

4D cells

In a spreadsheet comprising 4D cells, i.e. cells addressed by four variables, 4D cells may be displayed as different rooms in a storey. The rooms of a storey may be identified by displaying them in different colors or by displaying an identifier, such as a number, a letter, etc., with the room. The user is able to change room when he is on a storey, but all the rooms of all the storeys may also be changed at the same time. Typically, the user would use this feature to store different sets of test results in the same model.

An electronic data base system

As the electronic spreadsheet system is adapted to handle huge amounts of data, it may also be used in an electronic data base system by incorporating data base features into the system. The data base may be object-oriented.

Special

Insert rows and columns

When data has been entered into the spreadsheet document, it may be necessary to insert empty cells to make room for new data or to make empty areas in the document.

New, empty cells, areas, rows or columns can be created everywhere in the spreadsheet document; the original cells in the document are moved accordingly.

To insert a row,

1. Select (by clicking the label with the row number to the left of the document) the row after which the new row should be inserted, and

2. Perform the menu command Insert Row in the menu Edit.

To insert a column,

1. Select (by clicking the label at the top of the document) the column after which the new column should be inserted, and

2. Perform the menu command Insert Column in the menu Edit

To delete a row,

1. Select by clicking in the label to the left in the document the row (or rows) in question, and

2. Delete the row using the menu command Delete Row in the menu Edit.

To delete a column,

1. Select the column (or columns) in question by clicking in the label at the top of the document, and

2. Delete the row using the menu command Delete Column in the menu Edit.

To insert rows or columns in blocks,

1. Select a row going through a block,

2. Click the menu command Insert Row,

A dialogue box is displayed,

3. Click the check box Expand Block, and

4. Click OK.

When rows or columns in areas in which any blocks are positioned are to be deleted, the user has to decide whether he really wants to delete the block cells in the current rows or columns or not.

To delete rows or columns in blocks,

1. Click the menu command Delete Rows (or columns),

A dialogue box is displayed,

2. Answer the question “You are deleting rows/columns in a block!—Do you really want to delete the block cells?” with a Yes or No, and

3. Click OK.

Example Implementation

Example showing how easy it is to create a spreadsheet model with a block

It is assumed that the user is a sales manager who desires to create a sales budget concerning the salesmen in the company and that the report for January is as follows

| January | Wright | Jones | Petersen |
|---|---|---|---|
| Sales | 100100 | 100200 | 100090 |
| Transportation | 24000 | 23898 | 23999 |
| Representation | 1000 | 10000 | 3000 |
| Expenses | 50000 | 45999 | 45678 |
| Result | 25100 | 20303 | 27413 |

In a traditional two-dimensional spreadsheet, the first dimension could contain the names of the salesmen and the second dimension could contain the category labels regarding the sales. This would be very similar to the report itself.

Normally, a sales manager receives a new report every month and in this case it is convenient to present the new totals at once.

If the sales manager uses a traditional spreadsheet for this purpose, he has to create 12 spreadsheets in order to create the third dimension. If, he wants to calculate in the third dimension at a later stage, he has to create a further spreadsheet and use links to collect and add the results from the 12 months.

This method may also be used in the electronic spreadsheet system, but as it is both time consuming and tedious, the special third dimension in the electronic spreadsheet system is recommended. As shown it also provides the sales manager with a better overview of the situation.

To create a new block,

1. Select the cells to be included in the block,

2. Click the menu command New Block in the menu Block,

3. A dialogue box is displayed, and

4. Click the Create 12 months button.

A block having 12 storeys with the names of the month of a year is now created, and to enter category labels,

5. Enter the category labels into the global area to the left of the block (73).

In the illustration below the example is shown with all the numerical values filled in. The result is calculated for every salesman (74).

Attention is now focused on the summation and the ease with which it is performed in the third dimension. If it is desired to obtain the sum of Jones' sales for all the months (75), it is only necessary to click the menu command Block Sum and click the cell indicating Jones' sales (irrespective of the month displayed at that particular moment).

A month later, when new reports are received from the salesmen, it will only be necessary to fill in the numerical values for the new month and the calculations are updated immediately. It is not necessary to update any links.

It is now desired to calculate the result for every salesman through all the months and at the same time to have totals regarding the actual month written in the cells E3:E6 (77). In cell E7 the result for all the salesmen in the actual month (78) should be shown. Using Top Cell References the results will change moving from one month to another. This means e.g. that the results i column E will always reflect the corresponding month.

It is now desired to create a budget for the sales next year. The budget is based on the sales realized this year, but next year another salesman will be hired and therefore it is desired to add another column to the block.

To add a column to the block,

1. Select the row labelled E,

2. Click the menu command Insert Column,

3. Select the area outside the block, and

4. Click the menu command Add Cell to Block.

Later, it is communicated that salesman Jones is going to leave the company next year, and it is therefore necessary to delete column C.

To use Delete Column in block,

1. Select column C,

2. Perform the menu command Delete Column,

3. A dialogue box is displayed,

4. Answer the question whether you really want to delete column C With a Yes or No, and

5. Click OK.

Advanced example

The next example was made by a doctor and it shows that all relevant information may be included in the same screen view when using the block for storing three-dimensional data.

There are 34 patients in the block and each patient is subjected to Test 1 (79) the first year. Test 2 (80) is performed one year later.

As can be seen, the doctor did not have to copy the text or the formulas into all the pages of a workbook or notebook—she only had to write the text and formulas once in the global area (81) and consequently saved both memory and valuable time using the three-dimensional technique. The importance of saved memory spending increases when adding more patients to the block.

Data from the displayed storey (82) are compared with data from the global area (83)—(one diagram per storey in the block). The numerical values in column D are compared with the numerical values in the displayed storey, and both column B, C and D are illustrated in the diagram at the same time (84).

In traditional spreadsheet programs it would be necessary to paste a diagram into every page of the work book to make the same test. This will of course, take more time as the number of patients to be tested increases.

If the whole block (all the storeys) is to be printed, it can be decided whether the diagram is also to be printed with each storey.

When a storey is to be added, the “Add Storey”-button is simply clicked. It is then possible to fill in the data. Neither the text nor the formulas need be updated.

In traditional spreadsheet programs, it would be necessary to copy text onto the new page. The formulas would have to be updated and it should also be ensured that the format of the new page was the same as that of the other pages of the example. Finally, the diagram should be made while ensuring to add the same settings to this diagram as to the previous one; and it should be ensured that it was placed in the same position as the diagrams on the other pages of the example.

The delta-columns E and F illustrate the difference between the displayed data values in the block and the data values in column D. The delta-columns E and F show that a shift in storey will change the calculations in the global area.

The average for all the patients during the whole day in cell H19 (85) is calculated using the normal AVG-formula. In the three-dimensional spreadsheet, the ordinary formulas or the special timesaving block functions may be used for performing calculations in the third dimension. The block functions have the advantage that they need not be updated when adding new patients to the block.

The statistical results in the cells from B21 to B24 (86) are calculated using block functions. All values measured 8 am in all the patients are included. Please note that the results are displayed irrespective of the patient shown in the block.

If on the other hand, it is desired to exclude one or two patients from the calculations, this may be done by placing tags in the actual storeys. This is a much faster approach than using ordinary criteria which may also be used when calculating in the block.

The example shows that the doctor is able to have all relevant information concerning the patients on the same page. The example would occupy much more space if it was made in a traditional spreadsheet.

If a graphic illustration of the third dimension is desired a diagram may be made which shows a specific cell through all the storeys (e.g. patients 8 am test 1). The storeys to be included in the diagram may even be selected by using Block Criteria Graph.

The names of the storeys may be shown in a pop-up menu in the upper left corner of the document and it is possible to use either this menu, the up/down-buttons, the control-key or menu commands to go from one storey to another. Even the special pop-up menu underneath each block-cell can be used for viewing the values of the block cells or to shift between the storeys. In all, this is the most flexible way to shift between layers in the third dimension found in any spreadsheet.

Both names or numbers addressing the storeys may be used in formulas.

In this way, the doctor can use the block as her data base, and she would then be able to store information about all the patients in the block as it is able to hold more than 32.000 storeys (the traditional programs hold 256 pages and it would use a substantial amount of memory to use all 256 pages). Using the criteria, the doctor is able to work in the same data base (block) performing different tests and he may even sort the storeys in the block using the contents of a certain cell as a key.

In traditional spreadsheet programs, it would be necessary to copy the contents to the data base to perform the sorting here (in most spreadsheets this operation cannot be performed). Then the result would have to be pasted back into the workbook to perform the calculations here (in most traditional spreadsheets this operation cannot be performed).

Example showing a comparison between several storeys at the same time The production of cars both in the US and in Japan (information hidden in the block) is compared with the production of cars in the country at the moment displayed in the block (87) and the result is written in the columns E and F (88).

The category labels in the cells E2 and F2 (89) always reflect the country with which the current comparison is made.

To ensure the overview, the average of all countries (89) is shown in column D and the special Block Criteria Function is used to rule out Japan of the calculation of the average in column G (90).

If the same example was to be created in a traditional spreadsheet, it would be necessary to compare each country in the workbook or notebook with both the US and Japan. Therefore, the data would have to be copied into all the pages of the workbook or notebook. This would take time and use a lot of memory.

Details of the implementation

Paste Special with variable cell address adjustment

In a traditional spreadsheet, a formula can be copied in a cell and pasted into other cells in the spreadsheet.

In a traditional spreadsheet there are relative and absolute references.

| Formula | Column reference | Row reference |
|---|---|---|
| Cell address “A25” | “A” | “25” |
| = A25 | relative | relative |
| = $A25 | absolute | relative |
| = $A$25 | absolute | absolute |
| = A$25 | relative | absolute |

If the formula contains cell addresses, the row and/or column references (if relative) automatically adjust to their new location in the spreadsheet.

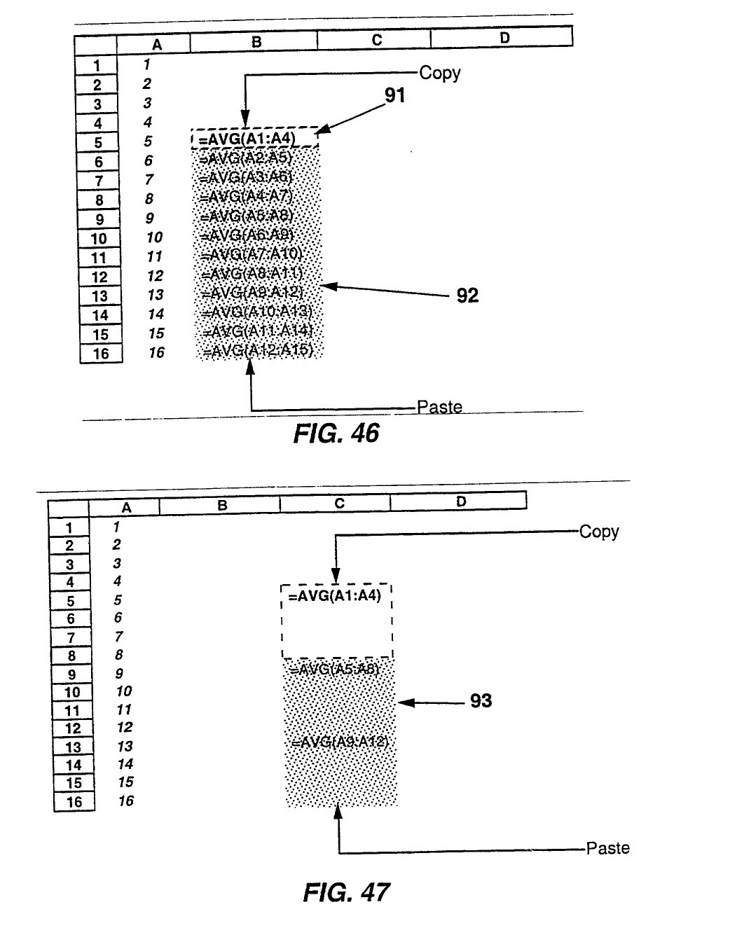

FIG. 46 shows what happens when the user copies the formula in cell B5 (91) and pastes it into the cells B6:B16 (92).

Values and formulas keyed in by the user are marked by italics and bold types. Cells that are copied are marked by a dashed line around them, and cells into which formulas are pasted are marked by grey dots in the background.

Cell B5 (the mother cell) contains a formula which calculates the average of the values in cells A1 to A4. The formula is copied and pasted into the cells B6 to B16. As a result, in the “B-column” a moving average is obtained of the values in the last 4 cells in the “A-column”. It is seen that the addresses in the formula adjust relatively to the new location of the formula. When moving down one row from the mother cell, the value of the row reference is increased by the value 1.

It is assumed that it is not desired to obtain a “simple moving average”; instead a “jumping average” is desired. Cell B5 still contains the average of the numbers in cell A1 to A4, but in cell B6 it is desired to obtain the average of cell A5 to A8, in cell B7 the average of cell A9 to A12 and so on. In a traditional spreadsheet, this cannot be done by the copy/paste function. If the copy/paste function is used, the user must accept that large gaps (93) between the cells in the spreadsheet (see FIG. 47) occur and this is often unacceptable even for small spreadsheet models. In a traditional spreadsheet, the solution is consequently, to key in the formulas in all the relevant cells.

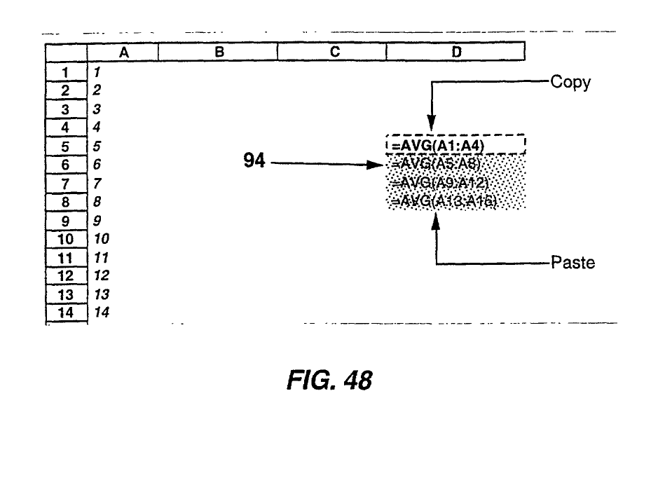

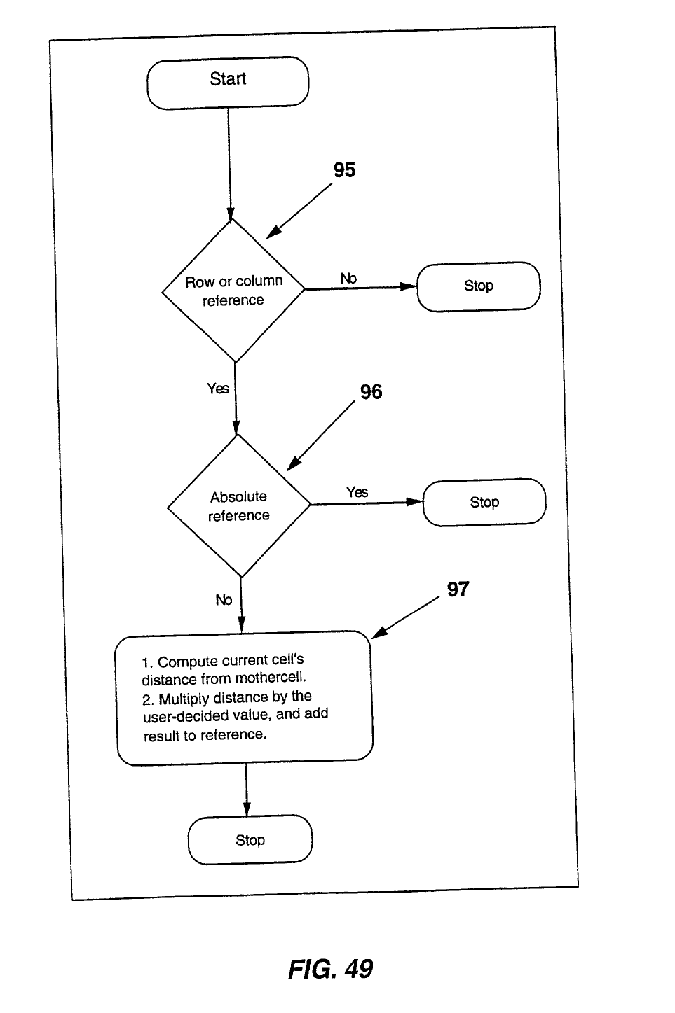

This invention introduces a possibility for the user to decide how cell addresses (row and/or column references) adjust when copied and pasted into a new location in the spreadsheet. The user can decide (e.g. in the “Paste Special dialogue box”) how many rows and/or columns a row and/or column reference will increase whenever moved one row/column away from the mother cell. In the example shown in FIG. 48, the user value is 4 (94).

Internal function of Paste Special with variable cell address adjustment

A cell formula copied and pasted into a cell is parsed to identify row and/or column references. When a column or row reference has been identified (95), it is tested whether it is an absolute reference (96). If not, the distance (in rows or columns) between the mother cell and the current cell is computed. The distance is then multiplied by the user-decided value and added to the row or column reference (97).

The invention works well both when using statistical functions as described above, but all functions known in the art may be used. Paste Special can be used with variable cell address adjustment both in the global area and in the block. In the block the invention can be used both in 2D (like in the global area) and in 3D (where pasting into cells that are not displayed).

Internal function

This invention can e.g. be implemented in the C++ programming language by using an object-oriented framework or a class library such as MacApp for Mac OS or OpenDoc for Windows and Mac OS. For information about C++, see e.g. Ellis, M. and Stroustrup, B., The Annotated C++Reference Manual, Addison-Wesley, 1990. Information about MacApp can be found in Programmers' Guide to MacApp and MacApp reference Guide, Apple Computer 1992. About OpenDoc see e.g. OpenDoc Programmers' Guide, Apple Computer 1995.

In the following the term “list” will be used in a broad sense including various possible implementations; e.g. sorted lists, arrays, binary search trees and hash tables.

1. Internal architecture

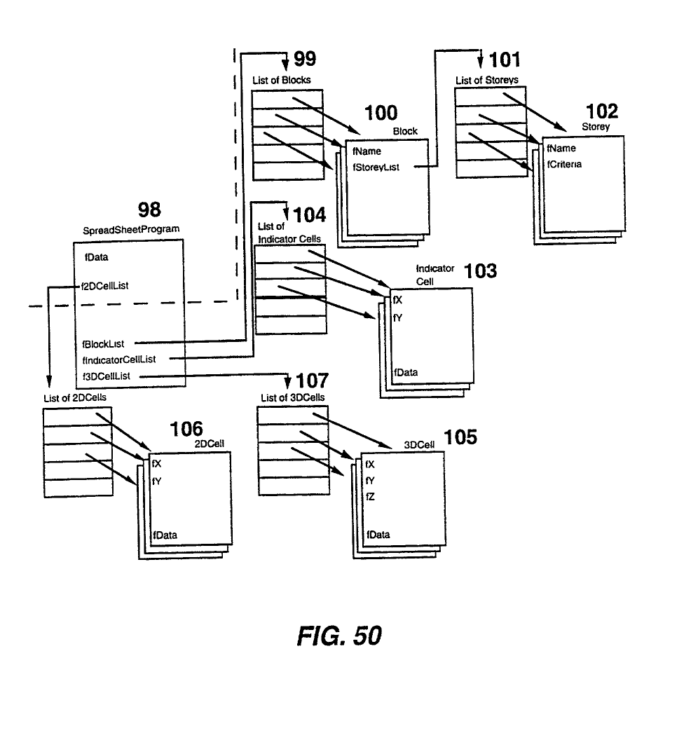

FIG. 50 shows the internal architecture of an embodiment of the invention.

The top left corner of the figure (indicated by a dashed line) corresponds to a traditional spreadsheet (98). In the following, the term ‘spreadsheet’ includes a page in a notebook-spreadsheet.

1.1. The list of blocks (“fBlockList”)

In the spreadsheet system, one or more blocks can be created with multiple layers of 3D cells. Each block has a variable number of storeys. Information about the block is recorded by the spreadsheet in a dynamic list, “fBlockList” (99). The first item of the list contains information about (e.g. pointers to or addresses to) the first block created, etc.

A block contains various items of data, among which information about the storeys of the block is of particular interest in the context of this invention (100). This information is stored in a dynamic list in the block, named “fStoreyList” (101). The first item in this list concerns (e.g. pointers to or addresses to) the first storey, etc. The block can be named and contains a data item holding the block name. By default, blocks are named “Block1”, “Block2”, etc.

Each storey corresponds to a z-coordinate in the spreadsheet and contains a number of data items (102). The storey can be named and consequently has an item holding the storey name. By default, storeys are named “No1”, “No2”, etc.

The user can associate a number of criteria with each storey. These criteria are of importance when calculations are performed within a block. Calculations may include or exclude 3D cells, depending on the criteria associated with the storeys in which the cells appear. A storey therefore has data items for such criteria.

1.2. The list of indicator cells (“fIndicatorCellList”)

Using so-called block cells, the spreadsheet currently records information about which regions contain multiple layers of 3D cells. For example, if the cell address “H8” is part of a block with multiple layers of 3D cells, the spreadsheet will have created an indicator cell at the address “H8”. This indicator cell has a column variable with value “H” and a row variable with value “8”. Thus an indicator cell indicates a position in the spreadsheet occupied by multiple layers of 3D cells.

An indicator cell contains various items of data (103). Of significance to the present invention is the fact that it has a column variable and a row variable which together indicate its position within the spreadsheet.

On the basis of the indicator cell positions, the spreadsheet is able to visually show the extent of each block, “the high-rise block”.

Indicator cells are recorded by the spreadsheet in a dynamic list, “fIndicatorCellList” (104).

1.3. The list of 3D cells (“f3DCellList”)

A 3D cell (3DCell) (105) contains various types of information also present in a 2D cell (106) (a 2D cell corresponds to a cell in a conventional spreadsheet): column coordinate, row coordinate, formula, number, etc. A 3D cell contains additional information about storey coordinate.

Information about the 3D cells is kept by the spreadsheet in a list, “f3DCellList” (107). The number of 3D cells in the spreadsheet is only limited by the hardware.

2. Dependency relations in the spreadsheet

2.1. Cell dependency

Cells in the spreadsheet depend upon each other according to their formulas. A cell B10 with formula “=A3+D8_{—}2” will, for example, depend on the cells A3 and D8_{—}2. This means that whenever one of these cells changes (e.g. because a new value of the cell is keyed in by the user), cell B10 must be recalculated in order to make the value of the cell correspond correctly to the cells on which B10 depends.

Let us assume that cell A3 contains a formula, “=A1/100”, and therefore depends on cell A1. If A1 is changed (e.g. by the user keying in a new value), this invokes a re-calculation not only of cell A3 which is directly dependent on A1, but also of cell B10 which (via the dependency relation to A3) depends indirectly on A1.

To handle such dependency, the spreadsheet keeps a list (“DependencyList”) for each cell. The list records cells that are directly depending on the cell in question. Thus, the spreadsheet can determine, when changes in one or more cells are made, what cells should be re-calculated and in what order.

2.2. Relative dependency of 3D cells in a block.

Let us assume by way of example that cell H10 has the formula “=H8*100” and thus depends on cell H8. It is further assumed that the cell address “H8” points to a part of a block in the spreadsheet with multiple layers of 3D cells. When the user browses through the block, it is simultaneously decided which storey of the block should be at the top and thus which 3D cells should be displayed in the spreadsheet. If the value in cell H10 is to reflect that a new cell with a different value is at the top of the spreadsheet, cell H10 must be re-calculated so as to be consistent with the displayed value in cell H8. Every time browsing brings a new cell to the top of the block, cell H10 must be re-calculated. Thus, in the example cell H10 depended on the cell currently displayed at H8. Such dependency is called relative 3D cell dependency.

The relative 3D cell dependency is ruled by the block cells. It should be recalled that block cells are place-holders for 3D cells in the spreadsheet, indicating positions with multiple layers of 3D cells. For every block cell, the spreadsheet keeps a list (“DependencyList”) of cells which depend on which 3D cell is displayed at the position of the block cell (in the example, the block cell was at position H8). On the basis of this information, and information on other cell dependencies, the spreadsheet can decide when a block is being browsed through, which cells should be re-calculated, and in which order.

2.3. Absolute dependency of 3D cells in a block.

In contradistinction to relative 3D cell dependency is absolute 3D cell dependency. It would for instance occur if the formula of cell H10 was changed to “=H8_{—}2*100”. In that case, cell H10 depends on the 3D cell on the second storey at cell address “H8”, regardless of the storey (and hence what 3D cell) currently displayed in the spreadsheet. To handle such dependency, the spreadsheet keeps a list (“DependencyList”) for every 3D cell, recording those cells which directly depend on the 3D cell in question.

2.4. Creation and maintenance of cell dependencies

Information on all types of cell dependency is created in the spreadsheet when cells are introduced into it. The information is updated/changed when new cells are added to the spreadsheet, when cell formulas are changed, when new blocks are created in the spreadsheet, and when new regions are added to or removed from existing blocks.

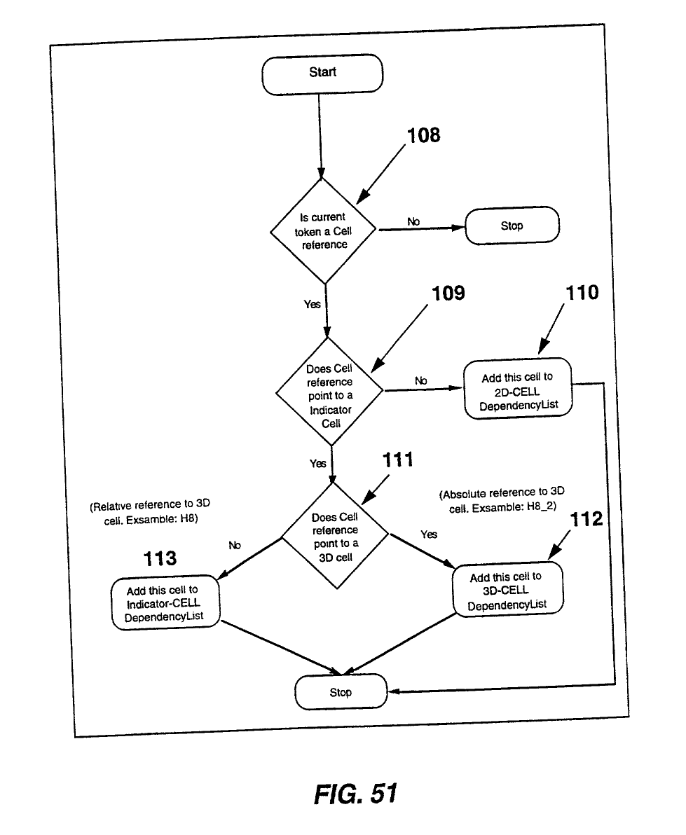

Cells being created or updated are processed by the spreadsheet as shown in FIG. 51. The formulas of the cells are parsed to identify cell references (108). When a cell reference has been identified, it is tested which the cell reference points to a block cell (109). If not, the current cell is added to the dependency list of the spreadsheet for the 2D-cell referred to (110).

If the cell reference does point to a block cell, it is tested whether or not the reference represents an absolute 3D cell dependency (which for example the reference “H8_{—}2” would do) (111). If so, the current cell is added to the dependency list of the spreadsheet for the 3D cell referred to (112). Otherwise, a relative 3D cell dependency is at hand (e.g. with a reference such as “H8”), and the current cell is added to the dependency list of the spreadsheet for the block cell referred to (113).

1. An electronic spreadsheet system comprising
a computer having memory means for storage of data and processing means for defining addressable spreadsheet cells stored in the memory means, for entering data into the spreadsheet cells and for processing data stored in the spreadsheet cells,
input means for entering data into the system, and
display means for displaying spreadsheet cells as a spreadsheet,
wherein at least one spreadsheet cell is addressable by a first number of variables that differs from a second number of variables addressing another spreadsheet cell.

2. A system according to claim 1, wherein at least one spreadsheet cell (2D spreadsheet cell) is addressed by two variables.

3. A system according to claim 1 or 2, wherein at least one spreadsheet cell (3D spreadsheet cell) is addressed by three variables.

4. A system according to any of claims 1-3, comprising at least one 2D spreadsheet cell and at least one 3D spreadsheet cell.

5. A system according to claim 4, wherein at least one group of spreadsheet cells is displayed as a virtual highrise block positioned on a document.

6. A system according to claim 5, wherein the document is a spreadsheet.

7. A system according to claim 6, wherein spreadsheet cells of more than two dimensions are displayed as a section of a spreadsheet positioned at the top of the corresponding virtual highrise block.

8. A system according to claim 7, wherein spreadsheet cells displayed at the top of a virtual highrise block correspond to a selected address value of the dimension displayed along the virtual highrise block.

9. A system according to claim 7 or 8, wherein a storey can be selected for display at the top of the corresponding highrise block by selection of a corresponding identifier from a list of storey identifiers, each of which identifies a specific storey of a selected highrise block, which list is displayed upon execution of a user command.

10. A system according to any of claims 7-9, further comprising an icon upon selection of which the storey level of the storey displayed on top of the corresponding highrise block is incremented by one.

11. A system according to any of claims 7-10, further comprising an icon upon selection of which the storey level of the storey displayed on top of the corresponding highrise block is decremented by one.

12. A system according to claim 7-11, wherein cells of the storey currently displayed can be referenced in a formula so that the formula is recalculated when a new storey is displayed.

13. A system according to claim 7-12, wherein each of one or more selected stacks of spreadsheet cells of a block is displayed in a two-dimensional format as a row of spreadsheet cells or a column of spreadsheet cells upon execution of a specific command.

14. A system according to claim 13, wherein upon selection of a specific spreadsheet cell of the spreadsheet cells displayed in a two-dimensional format, the storey comprising the selected spreadsheet cell is displayed at the top of the corresponding high rise block.

15. A system according to any of the preceding claims, comprising processing means for calculating values of formulas having input values comprising values of spreadsheet cells along a selected dimension.

16. A system according to any of the preceding claims, wherein a criterion relating to processing of spreadsheet cells of a storey, such as inclusion or exclusion of data values of spreadsheet cells of the storey in the calculation of a formula, or inclusion or exclusion of data values of spreadsheet cells of the storey in a chart, is derived from information stored in a memory location associated with the storey in question.

17. A system according to claim 16, wherein a criterion relating to processing of a group of spreadsheet cells of a specific storey, such as inclusion or exclusion of a spreadsheet cell of the group in a function, is derived from information stored in a memory location associated with the storey in question.

18. A system according to any of the preceding claims, comprising means for transferring a group of spreadsheet cells of the spreadsheet, such as a storey, together with display and processing means to a computer in such a way that a user operating the computer can read, change and/or recalculate the contents of the group of spreadsheet cells and transfer the updated contents of the group of spreadsheet cells back to the electronic spreadsheet system.

19. A system according to claim 18, further comprising means for receiving updated contents of a group of spreadsheet cells.

20. A system according to any of the preceding claims, further comprising processing means for pasting the contents of selected source spreadsheet cells addressed by two or more variables into selected target spreadsheet cells, wherein the address values of input variables of a formula in a source spreadsheet cell is incremented by a user selected value when the corresponding address variable of the target spreadsheet cells is incremented by one.

21. A system according to any of the preceding claims, further comprising means for sorting storeys according to the contents of selected spreadsheet cells of each storey.

22. A system according to any of the preceding claims, comprising graphical means for graphically displaying data values of selected spreadsheet cells.

23. A system according to any of the preceding claims, comprising graphical means for graphically displaying a chart of data values of spreadsheet cells currently displayed.

24. A system according to any of the preceding claims, further being adapted to be used in an electronic data base system.

25. A system according to any of the preceding claims, further being adapted to be used in an electronic relational data base system.

26. A system according to any of the preceding claims, further being adapted to be used in an electronic expert system.

27. A system according to any of the preceding claims, wherein the storey to be displayed in one highrise block is specified by the contents of a spreadsheet cell of a storey displayed on top of another highrise block.

28. A method of data processing comprising the steps of defining addressable spreadsheet cells to be stored in a memory means, wherein at least one spreadsheet cell is addressable by a first number of variables that differs from a second number of variables addressing another spreadsheet cell and displaying at least some of the spreadsheet cells as a spreadsheet.

29. A method according to claim 29, further comprising the step of displaying at least one group of spreadsheet cells as a virtual highrise block positioned on a document.

30. A method according to claim 29 or 30, wherein a list of positions of stacks is created, which list is updated upon creation of a new stack or deletion of an existing stack.
